(19) United States
(12) Patent Application Publication
(10) Pub. No.: US 2023/0337664 A1
(43) Pub. Date: Oct. 26, 2023

(54) FRUIT FLY CONTROL

(71) Applicant: MACQUARIE UNIVERSITY, New South Wales (AU)

(72) Inventors: Phillip TAYLOR, New South Wales (AU); Vivek KEMPARAJU, New South Wales (AU); Soo Jean PARK, New South Wales (AU)

(21) Appl. No.: 17/923,294

(22) PCT Filed: May 5, 2021
(86) PCT No.: PCT/AU2021/050415

§ 371 Date: Nov. 4, 2022

(30) Foreign Application Priority Data
May 5, 2020 (AU) 2020901422

(51) Int. Cl. A01N 31/02; A01N 25/04; A01P 17/00

(52) U.S. Cl. CPC A01N 31/02; A01N 25/04; A01P 17/00

(57) ABSTRACT

The technology relates to the use of 1-octanol, 1-nonanol, a combination thereof or compositions comprising either or both of 1-octanol and 1-nonanol for modifying the behaviour of tephritid fruit flies. In particular the 1-octanol, 1-nonanol or compositions described herein can be used to repel and/or modulate the feeding, mating or oviposition behaviour of tephritid fruit flies such as the Queensland fruit fly and the Mediterranean fruit fly.

### TECHNICAL FIELD

The technology relates to compounds that modify the behaviour of tephritid fruit flies. In particular, the technology relates to the use of 1-octanol, 1-nonanol, or both to control fruit flies belonging to the family Tephritidae.

### CROSS REFERENCE TO RELATED APPLICATION

This application claims the benefit of Australian Provisional Application No. 2020901422 filed 5 May 2020, which is incorporated by reference herein.

### BACKGROUND

The tephritid Queensland fruit fly, Bactrocera tryoni (Froggatt) (Q-fly), is a major pest of horticultural crops in eastern Australia, attacking many fruit crops in the four states that account for nearly 80% of the fruit production for the country. Heavy infestations can result in complete loss of unprotected crops. Q-fly is also considered a major quarantine pest and as such it presents regulatory and trade barriers. Q-fly has a very wide host-fruit range as well as possessing a wide bioclimatic potential and is thus an important pest.

Fruit fly control typically includes the use of lures and development of lures for fruit flies dates back to the late 1930s. The first male attractant identified for the melon fly, B. cucurbitae, was anisylacetone (4-(4-methoxyphenyl)butan-2-one). This discovery was quickly followed by the description of cuelure (4-(4-acetoxyphenyl)butan-2-one) or CL as an attractant for melon fly which is now the most commonly employed male lure for Q-fly.

Like many insects Q-fly have a sophisticated chemoreception system including olfactory receptors that sense volatile substances such as pheromones and various volatile substances associated with ripening fruit. Some substances such as common essential oils have means to repel such insects by causing a change in the chemoreception system and subsequently causing a change in the insect's behaviour. Substances acting on the olfactory receptor, such as N,N-diethyl-3-methylbenzamide (DEET) and p-menthane-3,8-diol (PMD), have been used as repellents.

Q-fly and related flies, such as the Mediterranean fruit fly, Ceratitis capitata (Medfly), are known as pests to the agricultural industry in Australia and elsewhere. Q-fly has been controlled by use of a range of toxic insecticides. Alternate methods for the control of Q-fly are desirable, since use of some toxic insecticides, including fenthion and dimethoate, is now highly restricted.

There remains a need for compounds that modify the behaviour of fruit flies and which can be used to control fruit flies. The present inventors have identified that 1-octanol, 1-nonanol, or both can modify the behaviour of tephritid fruit flies including but not limited to Bactrocera tryoni and Ceratitis capitata, and can be used in fruit fly control.

### SUMMARY

In a first aspect there is provided a composition when used for modifying the behaviour of a tephritid fruit fly, the composition comprising 1-octanol, 1-nonanol, or a combination thereof; and at least one carrier.

The behaviour modification may be selected from deterring or reducing oviposition, deterring or reducing feeding, deterring or reducing mating, and movement away from the 1-octanol, 1-nonanol, or the combination of 1-octanol and 1-nonanol.

The carrier may be a matrix, solvent, wax emulsion, or polymer.

In some embodiments the carrier is adapted to provide sustained or control release of the 1-octanol, 1-nonanol, or a combination thereof.

The matrix may be a gelator, for example a gelator selected from mannitol 1,6-dioctanoate (M8), α,α-trehalose 6,6′-dioctanoate (T8), 12-hydroxystearic acid (H12), and any combination thereof.

The composition may comprise comprises from 0.5% w/w to 10% w/w of the gelator.

The solvent may be selected from water, acetone, DMSO, methyl acetate, ethyl acetate, diethyl ether, diisopropyl ether, tetrahydrofuran, acetonitrile, or an alcohol such as methanol, ethanol, butanol, isopropanol, or glycerol.

The wax emulsion may be selected from a SPLAT emulsion, or an emulsion of paraffin, beeswax, a vegetable based wax, a hydrocarbon based wax, carnauba wax, lanolin, shellac wax, bayberry wax, sugar cane wax, a microcrystalline wax, ozocerite, ceresin, montan, candelilla wax, and combinations thereof.

The polymer may be selected from polyvinyl chloride, polyethylene, cellulose acylate, cellulose ethyl ether, cellulose diacylate, cellulose triacylate, cellulose acetate, cellulose diacetate, cellulose triacetate, a cellulose alkan, a cellulose aroyl, ethyl cellulose, cellulose acetate, cellulose acetate butyrate, cellulose acetate phthalate, cellulose acetate trimellitate, glyceryl monooleate, glyceryl monostearate, glyceryl palmitostearate, polyvinyl acetate phthalate, hydroxypropylmethylcellulose phthalate, hydroxypropylmethylcellulose acetate succinate, poly(alkyl methacrylate), poly(vinyl acetate), a poly vinyl alcohol, a polyacrylamide derivative, an ammonio methacrylate copolymer, poly acrylic acid and poly acrylate and methacrylate copolymers, aminoacryl-methacrylate copolymer, polyvinyl acetaldiethylamino acetate, copolymers of maleic anhydride and styrene, ethylene, propylene or isobutylene, a polyacrylamide, a polyox(polyethylene oxide), a diester of polyglucan, cellulose butyrate, cellulose propionate, shellac, chitosan, oleyl alcohol, zein, vegetable oil, an essential oils, and hydrogenated castor oil.

The wax may be selected from carnauba wax, beeswax, Chinese wax, spermaceti, lanolin, bayberry wax, white wax, yellow wax, candelilla wax, microcrystalline wax, castor wax, esparto wax, Japan wax, ouricury wax, rice bran wax, a ceresin wax, montan wax, ozokerite, a peat wax, paraffin wax, a polyethylene wax, and polyglycerol fatty acid esters.

In a second aspect there is provided a controlled release device comprising the composition defined in the first aspect.

In a third aspect there is provided a method of modulating the behaviour of a tephritid fruit fly comprising
a) identifying a target area frequented or likely to be frequented by fruit flies;
b) applying to a portion of the area an effective amount of 1-octanol, 1-nonanol, a combination thereof or the composition defined in the first aspect; and/or
c) placing the controlled release device of the second aspect in the area.

The method may further comprise further applications of an effective amount of 1-octanol, 1-nonanol, a combination thereof or the composition defined in any one of claims 1 to 10.

The method may further comprise additional placements of the controlled release device of the second aspect in the area.

The further applications or placements may be daily, every two days, every four days, every six days, weekly, two weekly, three weekly, or monthly.

The behaviour modulation may be one or any combination of a reduction in the incidence of oviposition, feeding, mating, and movement into the area.

The area may comprise a fruit or a fruit tree.

In a fourth aspect there is provided use of 1-octanol, 1-nonanol, or a combination thereof to modulate the behaviour of a tephritid fruit fly.

The 1-octanol, 1-nonanol, or combination thereof may be present in a matrix or in the controlled release device of the second aspect.

The matrix may be a gelator. For example a gelator selected from mannitol 1,6-dioctanoate (M8), α,α-trehalose 6,6′-dioctanoate (T8), 12-hydroxystearic acid (H12), and any combination thereof.

The behaviour modulation may be one or any combination of a reduction in the incidence of oviposition, feeding, mating, and movement towards the 1-octanol, 1-nonanol, or combination thereof.

The tephritid fruit fly may a fly from the genera, Bactrocera, Dacus, Zeugodacus, Ceratitis, Rhagoletis, or Anastrepha.

The tephritid fruit fly of the genus Bactrocera may be selected from Queensland fruit fly (Bactrocera tryoni), Bactrocera jarvisi, Bactrocera curvipennis, Bactrocera facialis, Bactrocera frauenfeldi, Bactrocera jarvisi, Bactrocera kirki, Bactrocera melanotus, Bactrocera neohumeralis, Bactrocera passiflorae, Bactrocera psidii, Bactrocera tau, Bactrocera trilineola, and Bactrocera trivialis. In one embodiment the tephritid fruit fly is Bactrocera tryoni or Bactrocera jarvisi.

The tephritid fruit fly of the genus Zeugodacus may be Zeugodacus cucumis.

The tephritid fruit fly of the genus Ceratitis may be selected from Ceratitis capitata, Ceratitis brachychaeta, Ceratitis caetrata, Ceratitis catoirii, Ceratitis cornuta, Ceratitis malgassa, Ceratitis manjakatompo, and Ceratitis pinax.

In one embodiment the tephritid fruit fly may be Ceratitis capitata (Med-fly).

Any discussion of documents, acts, materials, devices, articles or the like which has been included in the present specification is solely for the purpose of providing a context for the present invention. It is not to be taken as an admission that any or all these matters form part of the prior art base or were common general knowledge in the field relevant to the present invention as it existed before the priority date of each claim of this specification.

In order that the present invention may be more clearly understood, preferred embodiments will be described with reference to the following drawings and examples.

### BRIEF DESCRIPTION OF THE DRAWINGS

FIG. 1. Mobility of female Q-Fly in presence of Oecophylla cues. Female flies increased motility, measured by fly's velocity, acceleration, active time and distance moved, when exposed to ant cues. Differences across the set of treatments was analysed by Kruskal-Wallis test (P<0.0001) followed by Dunn's multiple comparison test against filtered air as control. Different letters above bars denotes significant difference from control. Air=Filtered Air; Non-predator=Plautia affinis; Oecophylla smaragdina=Oecophylla.

FIG. 2. Mobility of male Q-Fly in presence of Oecophylla cues. Male flies increased motility, measured by fly's velocity, acceleration, active time and distance moved, when exposed to ant cues. Differences across the set of treatments was analysed by Kruskal-Wallis test (P<0.0001) followed by Dunn's multiple comparison test against filtered air as control. Different letters above bars denotes significant difference from control. Air=Filtered Air; Non-predator=Plautia affinis; Oecophylla smaragdina=Oecophylla.

FIG. 3. Feeding in the presence of Oecophylla cues. Flies decreased foraging in the presence of Oecophylla cues and was measured by number of visits and time spent. Differences across the set of treatments was analysed by Kruskal-Wallis test (P<0.0001) followed by Dunn's multiple comparison test against filtered air control. Different letters above bars denotes significant difference from control. Air=Filtered Air; Non-predator=Plautia affinis; Oecophylla smaragdina=Oecophylla.

FIG. 4. Oviposition in the presence of Oecophylla cues. Flies decreased overall oviposition in the presence of Oecophylla cues. Differences across the set of treatments was analysed by Kruskal-Wallis test (P<0.0001) followed by Dunn's multiple comparison test against filtered air control. Different letters above bars denotes significant difference from control. Air=Filtered Air; Non-predator=Plautia affinis; Oecophylla smaragdina=Oecophylla.

FIG. 5. Prospecting cues from different parts of the Oecophylla. Volatiles from different parts of the ant, Oecophylla smaragdina, was extracted and subjected to olfactometer assays. Flies (male or female) made choices between YH (yeast hydrolysate) or YH+nn (yeast hydrolysate+extract from different parts of the ant). Repellence was measured by the lower amount of time spent by flies in a particular olfactometer zone. Extracts of Head and Headspace volatiles were active and were repellent towards flies.

FIG. 6. GC-EAD and GC-MS analysis. Head and Headspace volatiles were subjected to electrophysiology studies (GC-EAD). C1 (1-octanol) was found to trigger response in a fly's antenna. Further C1 (1-octanol) was subjected to olfactometer assays to prove its repellent efficacy. Flies spend less time in olfactometer arm containing C1.

FIG. 7. Oviposition assays. Representative oviposition plates with eggs laid in the presence of 1-octanol (C1) and without 1-octanol (Control).

FIG. 8. Eggs laid by Bactrocera tryoni (A), Bactrocera jarvisi (B), Zeugodacus cucumis (C), Ceratitis capitata (D), and Bactrocera kraussi (E) on control and treatment (1-octanol or 1-nonanol) oviposition plates. One-way ANOVA followed by Dunnett's multiple comparison test proved treatments were significantly different from control across all fruit flies tested (P<0.0001).

FIG. 9. Slow-release formulations of 1-octanol deterred oviposition as reflected by a) number of oviposition punctures and b) number of larvae in treated (mannitol 1,6-dioctanoate (M8); α,α-trehalose 6,6′-dioctanoate (T8); and 12-hydroxystearic acid (H12)) and control (Ctrl) fruits. Difference across the set of treatments was analysed by repeated measures one-way ANOVA (P<0.0001) followed by Tukey's multiple comparison test. Similar letters denote significant difference.

FIG. 10. Representative electrophysiological responses to 1-octanol and 1-nonanol in males and females of each tested species: Bactrocera tryoni (A), Bactrocera jarvisi (B), Bactrocera kraussi (C), Zeugodacus cucumis (D), and Ceratitis capitata (E). For Zeugodacus and Bactrocera species the electrophysiological response is also accompanied by gas-chromatograph output.

Unless specifically indicated to the contrary, the statistics for the figures were prepared using Kruskal-Wallis test followed by Dunn's Multiple Comparison test. Bars with * are significantly different from the control (AIR) n=30

### Definitions

Throughout this specification, unless the context requires otherwise, the word “comprise”, or variations such as “comprises” or “comprising”, will be understood to imply the inclusion of a stated element, integer or step, or group of elements, integers, or steps, but not the exclusion of any other element, integer or step, or group of elements, integers or steps.

As used herein, the term ‘fruit flies’ and ‘tephritid fruit flies’ are used to indicate all flies belonging to the family Tephritidae (Diptera).

As used herein the term ‘behaviour modification’ refers to any fruit fly behaviour including oviposition, feeding and movement. In some embodiments the term ‘behaviour modification’ includes reduced or deterred oviposition in a target area, reduced or deterred feeding in a target area, reduced or deterred mating in a target area, or means that less time (including no time) is spent in a target area, compared to a non-target area.

Thus, in some embodiments to repel a tephritid fruit fly means deterring the pest from remaining in a target area. ‘Repel’ also includes minimising the landings of the target pest on a target area.

A target area is any area in which the composition described herein or 1-octanol, 1-nonanol or a combination thereof is present. Target areas include, but are not limited to, areas in orchards, in fruit trees, greenhouses, produce packing facilities, produce storage facilities, vehicles, retail outlets, homes, commercial buildings.

The indefinite articles ‘a’ and ‘an’ mean ‘at least one’ or ‘one or more’ when used in this application, including the claims, unless specifically indicated otherwise.

### DESCRIPTION OF EMBODIMENTS

The technology relates to the use of 1-octanol, 1-nonanol, or a combination thereof, and compositions comprising 1-octanol, 1-nonanol, or a combination of 1-octanol and 1-nonanol and a suitable carrier as a modifier of fruit fly behaviour.

### Behaviour Modification

The compositions disclosed herein or 1-octanol alone, 1-nonanol alone, or a combination of 1-octanol and 1-nonanol can be used to modify a range of fruit fly behaviours. The modification of the behaviour (for example reduced mating or oviposition) is advantageous because it facilitates fruit fly control.

In some embodiments the composition comprising 1-octanol or 1-octanol alone is used to reduce, deter, or eliminate oviposition, for example in a target area.

In some embodiments the composition comprising 1-octanol or 1-octanol alone is used to reduce, deter, or eliminate feeding, for example in a target area

In some embodiments the composition comprising 1-octanol or 1-octanol alone is used to reduce, deter, or eliminate mating, for example in a target area.

In some embodiments the composition comprising 1-octanol or 1-octanol alone is used to repel the tephritid fruit flies, for example, the fruit fly may spend less time (including no time) in a target area compared to a non-target area.

1-octanol is a liquid at normal temperatures but being a volatile compound, it also easily forms a vapour at normal temperatures. Accordingly, in some embodiments the effect of the composition comprising 1-octanol or 1-octanol alone on the level of behaviour modification of the fruit fly is proportional to the concentration of the 1-octanol (the greater the concentration, the greater the effect). Similarly, in some embodiments the effect of the composition comprising 1-octanol or 1-octanol alone on a fruit fly is inversely proportion to the distance of the fly from the composition comprising 1-octanol or 1-octanol alone.

In other embodiments the modified behaviour induced by the composition comprising 1-octanol or 1-octanol alone persists after the fruit fly has been exposed to the composition comprising 1-octanol or 1-octanol alone.

In some embodiments the composition comprising 1-nonanol or 1-nonanol alone is used to reduce, deter or eliminate oviposition, for example in a target area.

In some embodiments the composition comprising 1-nonanol or 1-nonanol alone is used to reduce, deter, or eliminate feeding, for example in a target area

In some embodiments the composition comprising 1-nonanol or 1-nonanol alone is used to reduce, deter, or eliminate mating, for example in a target area.

In some embodiments the composition comprising 1-nonanol or 1-nonanol alone is used to repel the tephritid fruit flies, for example, the fruit fly may spend less time (including no time) in a target area compared to a non-target area.

1-nonanol is a liquid at normal temperatures but being a volatile compound, it also easily forms a vapour at normal temperatures. Accordingly, in some embodiments the effect of the composition comprising 1-nonanol or 1-nonanol alone on the level of behaviour modification of the fruit fly is proportional to the concentration of the 1-nonanol (the greater the concentration, the greater the effect). Similarly, in some embodiments the effect of the composition comprising 1-nonanol or 1-nonanol alone on a fruit fly is inversely proportion to the distance of the fly from the composition comprising 1-nonanol or 1-nonanol alone.

In other embodiments the modified behaviour induced by the composition comprising 1-nonanol or 1-nonanol alone persists after the fruit fly has been exposed to the composition comprising 1-nonanol or 1-nonanol alone.

In some embodiments the composition comprising a combination of 1-octanol and 1-nonanol or a combination of 1-octanol and 1-nonanol is used to reduce, deter or eliminate oviposition, for example in a target area.

In some embodiments the composition comprising a combination of 1-octanol and 1-nonanol or a combination of 1-octanol and 1-nonanol is used to reduce, deter, or eliminate feeding, for example in a target area

In some embodiments the composition comprising a combination of 1-octanol and 1-nonanol or a combination of 1-octanol and 1-nonanol is used to reduce, deter, or eliminate mating, for example in a target area.

In some embodiments the composition comprising a combination of 1-octanol and 1-nonanol or a combination of 1-octanol and 1-nonanol is used to repel the tephritid fruit flies, for example, the fruit fly may spend less time (including no time) in a target area compared to a non-target area.

1-octanol and 1-nonanol are liquids at normal temperatures but being volatile compounds, they also easily form vapours at normal temperatures. Accordingly, in some embodiments the effect of the composition comprising a combination of 1-octanol and 1-nonanol or a combination of 1-octanol and 1-nonanol on the level of behaviour modification of the fruit fly is proportional to the concentration of the combination of 1-octanol and 1-nonanol (the greater the concentration, the greater the effect). Similarly, in some embodiments the effect of the composition comprising a combination of 1-octanol and 1-nonanol or a combination of 1-octanol and 1-nonanol on a fruit fly is inversely proportion to the distance of the fly from the composition comprising a combination of 1-octanol and 1-nonanol or a combination of 1-octanol and 1-nonanol.

In other embodiments the modified behaviour induced by the composition comprising a combination of 1-octanol and 1-nonanol or a combination of 1-octanol and 1-nonanol persists after the fruit fly has been exposed to the composition comprising a combination of 1-octanol and 1-nonanol or a combination of 1-octanol and 1-nonanol.

### Compositions

In some embodiments 1-octanol alone is used to modify fruit fly behaviour. In other embodiments compositions comprising 1-octanol and at least one carrier are used to modify fruit fly behaviour.

The concentration of 1-octanol in the composition ranges from about 0.1% to about 99% by weight. For example, 1-octanol may be present in an amount of about 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or about 99%. Preferably, 1-octanol is present in a concentration ranging from about 0.1% to about 50% by weight. More preferably, 1-octanol is present in a concentration ranging from about 1% to about 25% by weight. Even more preferably 1-octanol is present in a concentration ranging from about 1% to about 10% by weight.

In some embodiments 1-nonanol alone is used to modify fruit fly behaviour. In other embodiments compositions comprising 1-nonanol and at least one carrier is used to modify fruit fly behaviour.

The concentration of 1-nonanol in the composition ranges from about 0.1% to about 99% by weight. For example, 1-nonanol may be present in an amount of about 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or about 99%. Preferably, 1-nonanol is present in a concentration ranging from about 0.1% to about 50% by weight. More preferably, 1-nonanol is present in a concentration ranging from about 1% to about 25% by weight. Even more preferably 1-nonanol is present in a concentration ranging from about 1% to about 10% by weight.

In some embodiments a combination of 1-octanol and 1-nonanol is used to modify fruit fly behaviour. In other embodiments compositions comprising a combination of 1-octanol and 1-nonanol and at least one carrier is used to modify fruit fly behaviour.

The combined concentration of 1-octanol and 1-nonanol in the composition ranges from about 0.1% to about 99% by weight. For example, the combined concentration may be present in an amount of about 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or about 99%. Preferably, the combined concentration ranges from about 0.1% to about 50% by weight. More preferably, the combined concentration of 1-octanol and 1-nonanol ranges from about 1% to about 25% by weight. Even more preferably the combination of 1-octanol and 1-nonanol is present in a concentration ranging from about 1% to about 10% by weight.

A skilled person in the art would be able to identify suitable ratios of 1-octanol and 1-nonanol present in the combination, and suitable ratios of 1-octanol and 1-nonanol present in the composition comprising the combination of 1-octanol and 1-nonanol.

The compositions described herein include a suitable carrier. The carrier may be, for example a liquid or matrix such as a gel or gelator. Alternatively, the carrier may be a disseminator such as a cotton wick or a polymer. Preferably the carrier functions to control the release rate of the composition.

In some embodiments, the compositions comprising 1-octanol, 1-nonanol, or a combination thereof are formulated for slow release using a gelator. Suitable gelators include mannitol 1,6-dioctanoate (M8), α,α-trehalose 6,6′-dioctanoate (T8), 12-hydroxystearic acid (H12) and combinations thereof.

In some embodiments the total concentration of the gelator or combination of gelators is in a range of from about 0.5% weight/weight (w/w) to at least about 10% w/w of the composition.

In one embodiment the composition comprises 0.5%, 1%, 2%, 4%, 5%, 6%, 7%, 8%, 9% or 10% w/w of H12, M8, T8 or combinations thereof.

In one embodiment, the 1-octanol, 1-nonanol, or a combination thereof are formulated for slow release using 1,6-dioctanoate (M8). For example the composition can comprise 0.5%, 1%, 2%, 4%, 5% w/w of M8.

In one embodiment, the 1-octanol, 1-nonanol, or a combination thereof are formulated for slow release using α,α-trehalose 6,6′-dioctanoate (T8). For example the composition can comprise 0.5%, 1%, 2%, 4%, 5%, 6%, 7%, 8%, 9% or 10% w/w of T8. In one embodiment the composition comprises 0.5%, 1%, 2%, 4%, 5% w/w of T8.

In one embodiment, the 1-octanol, 1-nonanol, or a combination thereof are formulated for slow release using 12-hydroxystearic acid (H12). For example the composition can comprise 0.5%, 1%, 2%, 4%, 5%, 6%, 7%, 8%, 9% or at least 10% w/w of H12. In one embodiment the composition comprises 5%, 6%, 7%, 8%, 9% or at least 10% w/w of H12.

In some embodiments there is provided a controlled release device comprising a solid or semi-solid gel of 1-octanol, 1-nonanol, or a combination thereof and a gelator such as mannitol 1,6-dioctanoate (M8), α,α-trehalose 6,6′-dioctanoate (T8), or 12-hydroxystearic acid (H12). In some embodiments the gelator is present at 0.5% weight/weight (w/w) to about 10% w/w of the gel in the controlled release device.

In some embodiment the controlled release device comprises a container having at least one opening. The solid or semi-solid gel is held by container. The container optionally comprises an impermeable or semipermeable membrane covering the at least one opening. In some embodiments the carrier may be a wax emulsion, for example such as the SPLAT™ (Specialized Pheromone and Lure Application Technology) emulsion described in U.S. Pat. No. 6,001,346, which is hereby incorporated by reference. SPLAT emulsions can be applied directly to vegetation and can be formulated in a wide range of viscosities and may be used with the compositions. The biodegradable wax carrier is selected from the group consisting of paraffin, beeswax, vegetable-based waxes such as soywax (soybean based), and hydrocarbon-based waxes such as Gulf Wax Household Paraffin Wax, paraffin wax, avg melting point of 53° C. (hexacosane), high molecular weight hydrocarbons), carnauba wax, lanolin, shellac wax, bayberry wax, sugar cane wax, microcrystalline, ozocerite, ceresin, montan, candelilla wax, and combinations thereof.

In some embodiments the carrier may be a polymer. For example the polymer may be cellulose acylate, cellulose ethyl ether; cellulose diacylate, cellulose triacylate, cellulose acetate, cellulose diacetate, cellulose triacetate, mono-, di- and tricellulose alkan, mono-, di- and tricellulose aroyl, ethyl cellulose, cellulose acetate, cellulose acetate butyrate, cellulose acetate phthalate, cellulose acetate trimellitate, glyceryl monooleate; glyceryl monostearate, glyceryl palmitostearate, polyvinyl acetate phthalate, hydroxypropylmethylcellulose phthalate, hydroxypropylmethylcellulose acetate succinate, poly(alkyl methacrylate), poly(vinyl acetate), poly vinyl alcohols, polyacrylamide derivatives ammonio methacrylate copolymers, poly acrylic acid and poly acrylate and methacrylate copolymers, aminoacryl-methacrylate copolymer, polyvinyl acetaldiethylamino acetate, copolymers of maleic anhydride and styrene, ethylene, propylene or isobutylene, polyacrylamides, polyox(polyethylene oxides), diesters of polyglucan, cellulose butyrate, cellulose propionate, shellac, chitosan, oleyl alcohol, zein, vegetable oils (e.g. safflower oil, palm oil, neem oil) and essential oils (e.g. tea tee, peppermint), jojoba oil, cotton seed oil, corn oil, hydrogenated cotton seed oil, hydrogenated castor oil and the like.

The carrier may be a wax. For example, the wax may be carnauba wax, beeswax, Chinese wax, spermaceti, lanolin, bayberry wax, white wax, yellow wax, candelilla wax, microcrystalline wax, castor wax, esparto wax, Japan wax, ouricury wax, rice bran wax, ceresin waxes, montan wax, ozokerite, peat waxes, paraffin wax, polyethylene waxes, and polyglycerol fatty acid esters.

In some embodiments the carrier may be a clay, such as a kaolin. A suitable kaolin clay is the ‘Surround® WP’ (NovaSource, Phoenix, USA).

In embodiments where the carrier is a disseminator it is envisaged that the 1-octanol, 1-nonanol, or the combination thereof or compositions comprising 1-octanol, 1-nonanol, or a combination thereof will be applied to the disseminator undiluted or in solution with a suitable solvent (liquid carrier) such as acetone or ethyl alcohol.

Other suitable solvents may be water, acetone, DMSO, methyl acetate, ethyl acetate diethyl ether, diisopropyl ether, or an alcohol; such as methanol, ethanol, butanol, isopropanol, or glycerol.

### Tephritid Fruit Flies

In some embodiments, 1-octanol and the compositions comprising 1-octanol modify the behaviour of tephritid fruit flies.

In some embodiments, 1-nonanol and the compositions comprising 1-nonanol modify the behaviour of tephritid fruit flies.

In some embodiments, a combination of 1-octanol and 1-nonanol or the compositions comprising a combination of 1-octanol and 1-nonanol modify the behaviour of tephritid fruit flies.

The tephritid fruit flies may be any tephritid fruit flies. For examples, in some embodiments the tephritid fruit flies may be from the genera Bactrocera, Dacus, Ceratitis, Zeugodacus, Anastrepha, or Rhagoletis.

The tephritid fruit flies may be Bactrocera tryoni (Queensland fruit fly), Bactrocera curvipennis, Bactrocera facialis, Bactrocera frauenfeldi, Bactrocera jarvisi, Bactrocera kraussi, Bactrocera kirki, Bactrocera melanotus, Bactrocera neohumeralis, Bactrocera passiflorae, Bactrocera psidii, Bactrocera tau, Bactrocera trilineola, Bactrocera trivialis, Dacus demmerezi, Dacus frontalis, Dacus solomonensis, Zeugodacus cucumis, or Anastrepha ludens. In an embodiment the tephritid fruit fly is Bactrocera tryoni

The tephritid fruit flies may be Ceratitis capitata (Mediterranean fruit fly), Ceratitis brachychaeta, Ceratitis caetrata, Ceratitis catoirii, Ceratitis cornuta, Ceratitis malgassa, Ceratitis manjakatompo, or Ceratitis pinax. In an embodiment the tephritid fruit fly is Ceratitis capitata (Mediterranean fruit fly).

Other examples of tephritid fruit flies include the following: Bactrocera abdoangusta, Bactrocera abdonigella, Bactrocera abdopallescens, Bactrocera abnormis, Bactrocera abscondita, Bactrocera abundans, Bactrocera aemula, Bactrocera aeroginosa, Bactrocera affinidorsalis, Bactrocera albistrigata, Bactrocera allwoodi, Bactrocera alyxiae, Bactrocera amoena, Bactrocera ampla, Bactrocera andamanensis, Bactrocera anfracta, Bactrocera angusticostata, Bactrocera angustifinis, Bactrocera anomala, Bactrocera anthracina, Bactrocera antigone, Bactrocera apicalis, Bactrocera aquilonis, Bactrocera assita, Bactrocera aterrima, Bactrocera atrifacies, Bactrocera atriliniellata, Bactrocera aurantiaca, Bactrocera aurantiventer, Bactrocera beckerae, Bactrocera beckerae, Bactrocera bimaculata, Bactrocera bogorensis, Bactrocera brachus, Bactrocera breviaculeus, Bactrocera brevistriata, Bactrocera bryoniae, Bactrocera buvittata, Bactrocera caledoniensis, Bactrocera carbonaria, Bactrocera caudata, Bactrocera ceylanica, Bactrocera chonglui, Bactrocera chorista, Bactrocera cibodasae, Bactrocera cilifera, Bactrocera cinnamea, Bactrocera circamusae, Bactrocera citroides, Bactrocera cognata, Bactrocera congener, Bactrocera consectorata, Bactrocera cucurbitae, Bactrocera curreyi, Bactrocera curta, Bactrocera curvipennis, Bactrocera curvipennis, Bactrocera daula, Bactrocera decumana, Bactrocera diaphora, Bactrocera distincta, Bactrocera dubiosa, Bactrocera dyscrita, Bactrocera elegantula, Bactrocera emittens, Bactrocera enochra, Bactrocera epicharis, Bactrocera erubescentis, Bactrocera facialis, Bactrocera fagraea, Bactrocera fallacis, Bactrocera fernandoi, Bactrocera frauenfeldi, Bactrocera fuliginus, Bactrocera fulvicauda, Bactrocera fulvifemur, Bactrocera furfurosa, Bactrocera furvescens, Bactrocera furvilineata, Bactrocera fuscitibia, Bactrocera gombokensis, Bactrocera gracilis, Bactrocera hantanae, Bactrocera heinrichi, Bactrocera hochii, Bactrocera holtmanni, Bactrocera hypomelaina, Bactrocera incisa, Bactrocera inconstans, Bactrocera indecora, Bactrocera infesta Bactrocera ishigakiensis, Bactrocera isolata, Bactrocera jarvisi, Bactrocera kinabalum, Bactrocera kirki, Bactrocera kraussi, Bactrocera lata, Bactrocera lateritaenia, Bactrocera laticosta, Bactrocera latissima, Bactrocera limbifera, Bactrocera lineata, Bactrocera lombokensis, Bactrocera longicaudata, Bactrocera longicomis, Bactrocera luzonae, Bactrocera macrovittata, Bactrocera maculifacies, Bactrocera makilingensis, Bactrocera malaysiensis, Bactrocera manskii, Bactrocera mayi, Bactrocera melanopsis, Bactrocera melanotus, Bactrocera melastomatos, Bactrocera merapiensis, Bactrocera minuta, Bactrocera, moluccensis, Bactrocera morobiensis, Bactrocera morula, Bactrocera mucronis, Bactrocera mulyonoi, Bactrocera neocognata, Bactrocera neohumeralis, Bactrocera neopallescentis, Bactrocera nigrescentis, Bactrocera nigrofemoralis, Bactrocera nigrotibialis, Bactrocera obfuscata, Bactrocera oblineata, Bactrocera obscura, Bactrocera ochracea, Bactrocera parafrauenfeldi, Bactrocera paramusae, Bactrocera passiflorae, Bactrocera paulula, Bactrocera pedestris, Bactrocera penecognata, Bactrocera peninsularis, Bactrocera perkinsi, Bactrocera perpusilla, Bactrocera persignata, Bactrocera petila, Bactrocera phaea, Bactrocera pisinna, Bactrocera profunda, Bactrocera propinqua, Bactrocera pseudocurcurbitae, Bactrocera pseudodistincta, Bactrocera psidii, Bactrocera pusilla, Bactrocera qiongana, Bactrocera quadrata, Bactrocera quasisilvicola, Bactrocera quaterna, Bactrocera recurrens, Bactrocera redunca, Bactrocera reflexa, Bactrocera rhabdota, Bactrocera robertsi, Bactrocera, robiginosa, Bactrocera rubigina, Bactrocera rufescens, Bactrocera rufofuscula, Bactrocera rufula, Bactrocera russeola, Bactrocera salamander, Bactrocera scutellaris, Bactrocera scutellata, Bactrocera selenophora, Bactrocera sembaliensis, Bactrocera sicieni, Bactrocera silvicola, Bactrocera simulata, Bactrocera singularis, Bactrocera strigifinis' Bactrocera sumbawaensis, Bactrocera surrufula, Bactrocera synnephes, Bactrocera tau, Bactrocera thistletoni, Bactrocera tinomiscii, Bactrocera transversa, Bactrocera triangularis, Bactrocera trichota, Bactrocera trifaria, Bactrocera trifasciata, Bactrocera trilineata, Bactrocera trilineola, Bactrocera trivialis, Bactrocera tryoni, Bactrocera turneri, Bactrocera umbrosa, Bactrocera unifasciata, Bactrocera unilineata, Bactrocera univittata, Bactrocera usitata, Bactrocera ustulata, Bactrocera varipes, Bactrocera vishnu, Bactrocera vulgaris, Bactrocera vultus, Bactrocera yoshimotoi, Dacus absonifacies, Dacus aequalis, Dacus africanus, Dacus alarifumidus, Dacus ambonensis, Dacus axanus, Dacus badius, Dacus bakingiliensis, Dacus bancrofti, Dacus bellulus, Dacus bivatta, Dacus bivittatus, Dacus calirayae, Dacus capillaris, Dacus chiwira, Dacus choristus, Dacus concolor, Dacus demmerezi, Dacus devure, Dacus diastatus, Dacus discors, Dacus dissimilis, Dacus durbanensis, Dacus eclipsus, Dacus eminus, Dacus famona, Dacus formosanus, Dacus frontalis, Dacus guangxianus, Dacus hardyi, Dacus humeralis, Dacus ikelenge, Dacus kariba, Dacus lagunae, Dacus langi, Dacus leongi, Dacus longicomis, Dacus nadanus, Dacus nanggalae, Dacus newmani, Dacus ooii, Dacus, pallidilatus, Dacus palmerensis, Dacus parater, Dacus pecropsis, Dacus pleuralis, Dacus punctatifrons, Dacus ramanii, Dacus sakeji, Dacus santongae, Dacus secamoneae, Dacus siamensis, Dacus signatifrons, Dacus solomonensis, Dacus sphaeroidalis, Dacus telfaireae, Dacus tenebrosus, Dacus trimacula, Dacus vijaysegarani, Dacus xanthophterus.

### Methods

1-octanol, 1-nonanol, or a combination thereof and compositions comprising 1-octanol, 1-nonanol, or a combination thereof can be used to repel a tephritid fruit fly by exposing or subjecting the fruit fly to an effective amount of 1-octanol, 1-nonanol, the combination or the composition.

1-octanol, 1-nonanol, or a combination thereof and compositions described herein can be used to modulate the behaviour of a tephritid fruit fly for example the feeding, mating and/or oviposition behaviour by exposing or subjecting the fruit fly to an effective amount of 1-octanol, 1-nonanol, or the compositions described herein. In particular, the 1-octanol, 1-nonanol, or a combination thereof and compositions comprising 1-octanol, 1-nonanol, or a combination thereof can be used to eliminate or reduce the incidence of oviposition in an area surrounding the 1-octanol, 1-nonanol, or the combination thereof or the compositions comprising 1-octanol, 1-nonanol, or the combination thereof.

Accordingly, the methods to repel and modulate the oviposition, mating and/or feeding behaviour can be used individually or collectively to control tephritid fruit fly.

In practice, 1-octanol, 1-nonanol, or a combination thereof and the compositions disclosed herein are often used in a manner similar to a trap bait or applied to a surface in an effective amount.

An effective amount is defined as that quantity of the 1-octanol, 1-nonanol, or a combination thereof or the compositions disclosed herein that repels fruit flies from the location of the compounds and compositions described herein. Factors such as insect population density, temperature, wind velocity, release rate, and method of application will influence the actual number of flies repelled. A skilled person can readily determine an effective amount in a particular set of circumstances by a dose response field test.

In methods involving the use of 1-octanol, 1-nonanol, or a combination thereof or compositions comprising 1-octanol, 1-nonanol, or a combination thereof to modulate the feeding, mating and/or oviposition behaviour of a tephritid fruit fly, an effective amount is defined as that quantity of 1-octanol, 1-nonanol, or a combination thereof or the compositions comprising 1-octanol, 1-nonanol, or a combination thereof that reduces the level of feeding, mating or oviposition in the location of the compounds and compositions described herein. As above, factors such as insect population density, temperature, wind velocity, release rate, and method of application will influence the level of reduction. A skilled person can readily determine an effective amount in a particular set of circumstances by a dose response field test.

In another embodiment methods to control fruit flies using 1-octanol, 1-nonanol, or a combination thereof and compositions comprising 1-octanol, 1-nonanol, or a combination thereof involve detecting or identifying the target area and/or boundaries of localized fruit fly infestations and applying 1-octanol, 1-nonanol, or a combination thereof or a composition thereof in at least part of the target area. As with the use of insecticides, this method eliminates the need to spread the control agents unnecessarily and potentially minimizes adverse impact to useful insects and the environment.

In another embodiment methods of modulating the behaviour of fruit flies involve identifying a target area frequented or likely to be frequented by fruit flies and applying to a portion of the area an effective amount of 1-octanol, 1-nonanol, a combination thereof or a composition comprising 1-octanol, 1-nonanol, or a combination thereof; and/or placing a controlled release device as described herein in the area. In certain embodiments, methods of modulating the behaviour of fruit flies further comprises further applications of an effective amount of 1-octanol, 1-nonanol, a combination thereof or the composition defined herein. In some embodiments, the methods further comprise additional placements of the controlled release device described herein in the area. In some embodiments, the further applications or placements defined in the methods are daily, every two days, every four days, every six days, weekly, two weekly, three weekly, or monthly.

In one embodiment, the target area defined in the methods of modulating or controlling behaviour of a tephritid fruit fly comprises a fruit or a fruit tree.

Various formulations of the 1-octanol, 1-nonanol, and combinations thereof can be combined with slow-release systems including gelators, micro-beads, silicon-based formulas, microencapsulation, etc. to extend the repellent time. The formulations can be constituted such that they release the active ingredient only (or preferably) over a period of time (i.e., a sustained-release formulation). The coatings, envelopes, and protective matrices may be made, for example, from polymeric substances or waxes and the pharmaceutically acceptable.

1-octanol, 1-nonanol, or a combination thereof and compositions comprising 1-octanol, 1-nonanol, or a combination thereof may be applied as frequently as needed, based on the characteristics of the target area and the nature and concentration of the target pests to be repelled.

In order that the present invention may be more clearly understood, preferred embodiments will be described with reference to the following drawings and examples.

### EXAMPLES

### Arena Evaluation

### Example 1: Insects

Queensland fruit flies, Bactrocera tryoni (Diptera: Tephritidae), were obtained from a colony originating from central coastal New South Wales and maintained in a controlled environment laboratory at Macquarie University (25±0.5° C., 65±5% RH, photoperiod of 11.5:0.5:11.5:0.5 light:dusk:dark:dawn) for 29 generations. Adult flies were fed yeast hydrolysate, sugar and water ad libitum.

Green tree ants (major workers) were collected from 5 different nests in the vicinity of Mareeba Research Facility, Department of Agriculture and Fisheries, QLD, Australia (17.00724° S, 145.42984° E). Worker ants were selected as they were the ones that forage and attack prey. The insects were directly extracted or dissected in the laboratory. The collected samples were transported to Macquarie University, Sydney and prepared for GC-MS analysis.

Responses of flies to a non-predatory stinkbug, Plautia affinis, were also assessed and the stinkbugs were obtained from orange orchards in Somersby, NSW. The non-predator was used in this study as a positive control against the possibility that the flies simply respond in a generic way to olfactory cues from any insect source.

### Example 2: Olfactory Cues from Ants and Non-Predators

Olfactory cues from predators or non-predators were obtained by blowing charcoal filtered air over ants or non-predators into arenas. A 50 ml closed glass volatile collection chamber (Sigma-Aldrich, USA), with an inlet and outlet, containing a single spider, a group of 6 ants or a non-predator, was set-up 30 min before each experiment to allow a build-up of olfactory cues within the chamber and control was an empty glass chamber. After 30 min, charcoal filtered air was passed through the chamber to carry olfactory cues from the volatile collection chamber into the test arenas using a gas sampling pump (KNF Pumps, Model no. NMP850.1.2KNDCB, Switzerland) at a rate of 1 L/min.

### Example 3: Arenas and Software

Two kind of arenas were designed for this study. A behavioural arena was used for analysis of motility, foraging and mating, while an oviposition arena was used to assess oviposition behaviour. The behavioural arena comprised a closed, clear polystyrene Petri dish (145 mm×20 mm dia.). The Petri dish was covered on all sides with white lamination paper (100 mm high) to mitigate possible positional biases caused by external visual stimuli. The arena had 2 holes (5 mm dia.) on the sides for inlet and outlet of olfactory cues or filtered air. Video recordings were carried out with an overhead HD camera (Go Video, Digital 540TLV) at recording speed of 25 frames per second. The arena was placed 1 m below the camera and was lit by fluorescent lights, although recordings at dusk were enabled using infrared lighting. The camera was connected to a digital video recorder and each recording was for 10 min. The oviposition arena was a cylindrical clear polystyrene jar (150 mm×90 mm dia.). Two holes (5 mm dia.) on the sides of the jar served as inlet and outlet for olfactory cues or filtered air. An Eppendorf tube (5 ml), with numerous 1 mm diameter holes on the upper half, served as oviposition device. Mango juice was used as an oviposition stimulant. After each trial, the arenas were washed with warm water, wiped with 70% ethanol and air dried for 20 min. The recorded video was subjected to locomotion analysing software Lolitrack Ver 4 (Loligo Systems, Denmark) and BORIS V6.3.4 software (Friard & Gamba 2016). Lolitrack was used to track the active time, velocity, acceleration, distance moved, time spent in zones, number of visits to zones and x, y coordinates of flies. BORIS V6.3.4 software was used to record mating behaviour.

### Example 4: Bioassays

For motility assays, a 10-day old virgin male or female fly was placed in the arena and was allowed to acclimatize for 20 min, after which an olfactory cue or filtered air was pumped into the arena through the inlet. Fly movement was recorded for 10 min. Velocity, acceleration, active time and distance moved were analysed using Lolitrack software. The foraging assay was conducted following Zaninovich et al. (2013) with minor changes. A single virgin 10-day old male or female fly that had not been fed for 24 hours was introduced into the arena and allowed to acclimatize for 20 min. Next, filtered air or air containing olfactory cues from predators or non-predator was pumped through the inlet of the arena for 1 min before dispensing 100 uL of sugar solution using a micropipette onto the centre of the arena demarcated as ‘food zone’. The food zone consisted of a Petri dish (5 cm dia.) containing the sugar solution. Foraging activity of the fly was recorded for 10 min and the recorded video was analysed using Lolitrack software. The number of visits made, and time spent by flies in the food zone was recorded and analysed. Oviposition assays were conducted using the oviposition arena. A single 15-day-old gravid female was introduced into the arena and was allowed to acclimatize for 20 min. An oviposition device, containing mango juice as oviposition stimulant, was placed on the floor in the centre of the arena. Simultaneously, olfactory cues (from predator or non-predator) or filtered air was pumped through the inlet of the arena. The flies were allowed to oviposit for −16 h. The collected eggs were washed into a Petri dish and counted under a stereo microscope (Leica Microsystems, Germany). All experiments were repeated 30 times.

### Example 5: Extraction of Cuticular Compounds

Ants (n=100) were dipped into 10 mL of hexane for 10 seconds to extract cuticular compounds (CCs). A total of 27 CC samples were collected and stored at 5° C. until further use.

### Example 6: Extraction of Compounds from Dufour's and Poison Glands

Ants were collected in plastic vials (50 mL) and placed in a freezer (−20° C.) for 10 minutes to kill them. Dufour's glands were obtained by pulling the last segment of abdomen. The remnant tissues around the gland were carefully removed using fine forceps. Ten clean glands were immediately placed into 1.5 mL of hexane to extract gland contents. The poison gland is located in the abdomen, close to the Dufour's gland, and these were dissected and collected in a similar manner. Ten samples of extracts from each gland were collected and stored at 5° C. until further use.

### Example 7: Extractions of Headspace Volatiles

An air entrainment system was used to collect headspace volatiles samples of ants. A cylindrical glass chamber (150 mm long×40 mm ID) with an inlet and outlet at the ends was used to hold ants. A charcoal filter was connected to the inlet (4 mm ID) of the glass chamber using Tygon tubing (E-3603). The outlet of the glass chamber was connected to a Tenax tube (50 mg, Scientific Instrument Services, Inc, Tenax-GR Mesh 60/80) fitted to a screw cap with O-ring. Ten ants were placed inside the glass chamber and were allowed to acclimatize for 30 minutes prior to collection of volatiles. Nine chambers with ants and one empty chamber as a control were setup in each run. Headspace volatiles were adsorbed into Tenax packed in glass tubes (6×50 mm) at a flow rate of 0.5 L/min for 30 minutes. Green tree ants are highly active in afternoons; therefore, all collections were conducted between 2 to 4 μm. The adsorbed volatiles were eluded with 1 mL of hexane into a clean 1.5 mL sample vial. A total of 36 samples were collected. A control in each experiment were used to identify any background impurities. All collections were stored at 5° C. until further use.

### Example 8: Extraction of Ant Trail Compounds

Green tree ants at Mareeba research facility had nests close to a metal wire fence. This metal wire fence served as their regular path to transport food and other materials to the nest. Prior to collection, the section of fence (— 3 m) that the ants used was washed with acetone (100 mL) to remove any pre-existing trail chemicals. The ants were allowed to make a trail on the washed section of the metal wire for 24 h. Next, during periods of high ant activity, the metal wire was washed, section by section, with a total of 100 mL hexane into a beaker (500 mL). The trail wash was concentrated under a gentle stream of clean air to about 10 mL. A total of ten samples was collected. All collections were stored at 5° C. until further use.

### Example 9: Extraction of Compounds in the Head of Ants

Heads of green tree ants contain many glands and are rich in volatile compounds. Many compounds from their head are known to be used for communication/defense. Collected green ants were killed by placing them in −20° C. Ten heads were removed with dissecting scissors and immediately placed in 1.5 mL of hexane in a glass vial. A total of seven samples (each containing 10 heads) were collected and stored at 5° C. until further use.

### Example 10: Sample Processing

CHCs, Dufour's gland, poison gland and head samples contained minute quantities of water/debris and were removed by adding a drying agent (sodium sulfate) and by gravity filtration. Samples free from water and debris were concentrated under a gentle stream of nitrogen gas. Cuticular compound samples were concentrated to 1 mL while Dufour's gland, poison gland and head samples were concentrated to 0.5 mL. Trail samples were filtered to remove solid matter and concentrated to 1 mL under gentle stream of nitrogen gas. Headspace volatile samples did not require further processing. All samples were stored at −20° C. until further analysis.

### Example 11: Gas Chromatography Mass Spectrometry (GC-MS) Analysis

GC-MS analysis was carried out on a Shimadzu GC-MS TQ8030 spectrometer equipped with a split/splitless injector and SH RTX-5MS (30 m×0.25 mm, 0.25 μm film) fused silica capillary column. Carrier gas was helium (99.999%) at a flow rate of 1 mL/min. An aliquot of 1 μL sample was injected at splitless mode where the injector temperature was 270° C. The temperature program for CHCs, head extracts and trail were as follow: 50° C. for 1 min to 280° C. at 10° C. min⁻¹, then increased to 300° C. at 2° C. min⁻¹. The temperature program for Dufour's gland, poison gland and headspace extracts were as follows: 50° C. for 1 min to 280° C. at 10° C. min⁻¹, then increased to 300° C. at 5° C. min⁻¹. The ion source and transfer line temperatures were 200° C. and 290° C. respectively. The ionization method was electron impact at a voltage of 70 eV. The spectra were obtained over a mass range of m/z 45-650. For identification the mass spectra were analysed by Shimadzu GC-MS post run and compared with authentic samples, NIST library (NIST17-1, NIST17-2, NIST17s) and mass fragmentation patterns or Kovat indices published in the literature.

For the structural assignments of methyl branched hydrocarbons, the chain length and the number of inner branched methyl groups were established by examining an equivalent chain length and molar mass of a compound. Molecular ions of inner branched hydrocarbons often do not appear or are weak in mass spectra and hence a molar mass of a branched hydrocarbon was established by examining fragmentations of M−15, M−29 and so on. The fragmentation of a branched hydrocarbon generates not only odd mass, but even mass secondary ion by hydride transfer if the chain length is sufficiently long enough. Intensities of these ions depend on whether a secondary fragment ion has an inner branch and on the carbon chain length of such an ion. These generalizations of mass peaks of branched hydrocarbons were used to assign the identity and branch positions of a hydrocarbon.

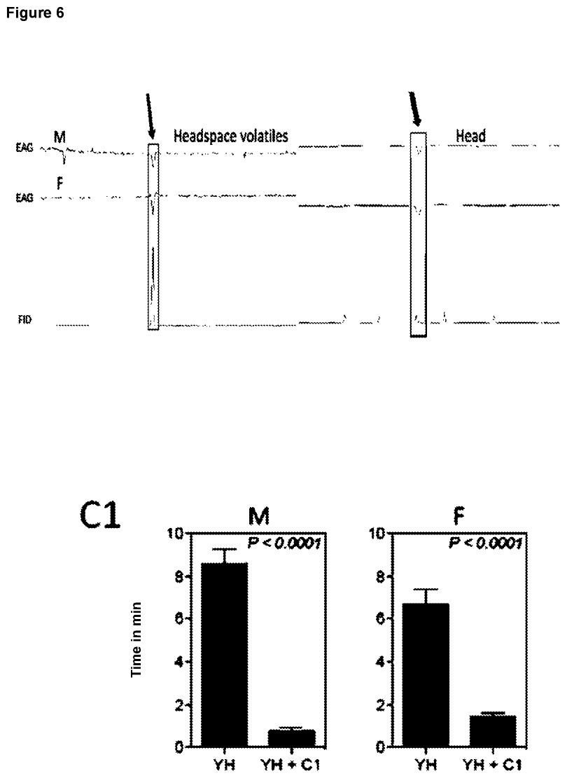

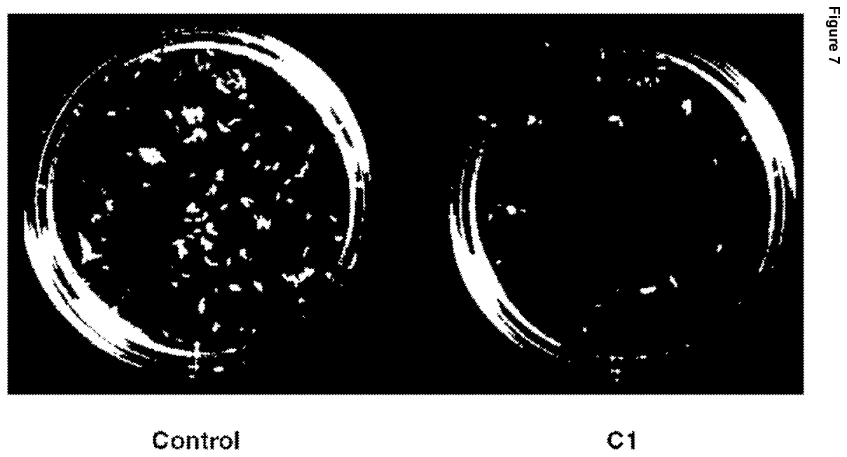

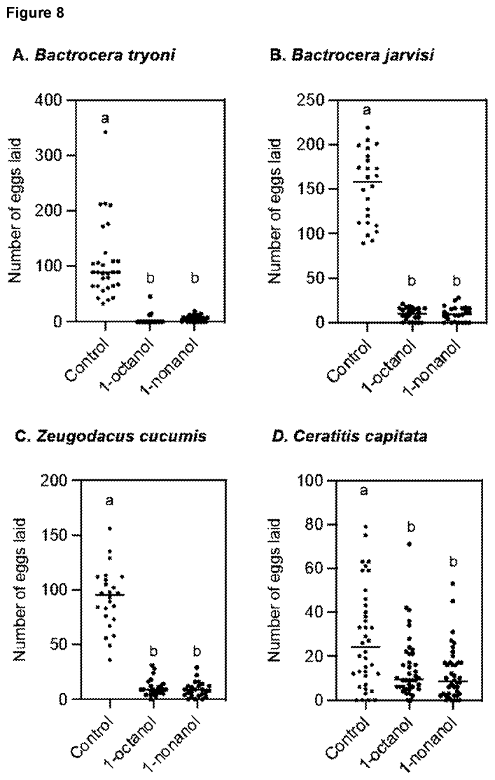

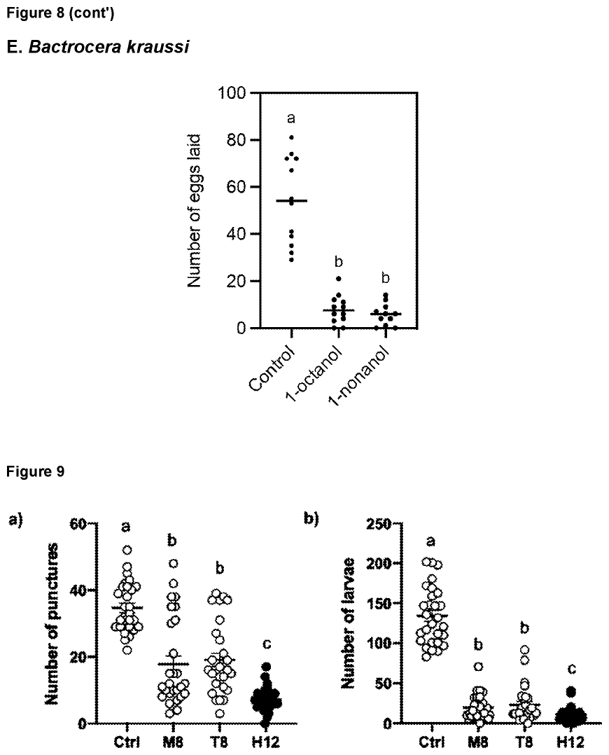

With reference to FIG. 6, compound C1 was identified as 1-octanol using this method.

### Example 12: Electrophysiology

Coupled Gas Chromatography-Electroantennography (GC-EAG) recordings were made with Ag-glass microelectrodes filled with electroconductive gel (Spectra 360, Parker Laboratories Inc., USA). The head of male or female Bactrocera tryoni, anaesthetized by chilling, was separated from the body with a microscalpel and was placed on the tip of the indifferent electrode, making sure the base of the head is affixed to the gel in the electrode. The tip of the insect antenna was made to touch the recording electrode and was slightly inserted into the gel to stabilize the antenna. The signals were passed through a high impedance amplifier (UN-06, Syntech, Hilversum, The Netherlands) and analysed using a software package provided by Syntech.

Each extract-cuticular compounds, Dufour's glands, poison glands, trail, headspace, and head extractions were tested individually. After injection of extraction samples, the effluent from the GC column was simultaneously directed to the antennal preparation and the GC detector. Separation of compounds was achieved on an Agilent Gas Chromatography system equipped with a column injector and a flame ionization detector (FID), using an Agilent HP-5 column (30 m×0.32 mm, 0.25 μm film). The oven temperature was maintained at 40° C. for 2 min, and then programmed a 10° C. min-1 to 250° C., and the carrier gas was hydrogen (99.999% purity) supplied by a generator (MGG-2500-220 Parker Balston, New York) with a constant flow of 2.5 mLmin⁻¹. The injector and detector temperatures were set at 270 and 290° C., respectively. The effluent of the column was mixed with 30 mL/min nitrogen make-up gas and split in a ratio of 1 (FID) to 1.5 (EAD). The eluent to EAD was passed through a heated transfer line (Syntech, TC-02, Syntech, Hilversum, The Netherlands) at 200° C. The outputs from the EAG amplifier and the FID were monitored simultaneously and analysed using the Syntech software package. Peaks eluting from the GC column were judged to be active if they elicited EAG activity in three or more of the ten coupled runs carried out. The identities of FID peaks were confirmed by GC-MS operating at the same GC conditions with the same type of column (5% polydiphenylsiloxane and 95% polydimethylsiloxane).

### Example 13: Olfactometer Bioassays

An acrylic four-arm olfactometer (120 mm dia.) was used to measure behavioural responses of Bactrocera tryoni males/females to food (yeast hydrolysate) with or without 1-octanol (EAG-active compound). Prior to each experiment, acrylic components were washed with a non-ionic detergent solution, rinsed with ethanol solution and distilled water, and left to air dry. Experiments were conducted in a controlled environment room (25±2° C., 60% RH). The central area was fitted with a filter-paper base (Whatmann No. 1, 12 cm dia.) to provide traction for the walking insects. The room was illuminated from above by uniform lighting from white fluorescent light bulbs to negate directional bias. Individual flies (10-15 days old) were introduced through a hole below the olfactometer. Each fly was given 5 min to acclimatize in the olfactometer, after which the experiment was run for 10 min for each replicate. The olfactometer was rotated 90° after each replicate to eliminate any directional bias in the room. Air was drawn through the central hole at 200 ml min-1 and subsequently exhausted from the room. The central arena of the olfactometer was divided into four discrete odour fields corresponding to each of four inlet arms. A choice test was performed that used two different opposite arms. Test samples (10 μl) were pipetted onto filter paper strips placed into the arms. Flies starved for 24 h was allowed to make a choice between the treatments. Fly activity in each olfactometer was video recorded. The time spent in each arm was recorded using BORIS software. The mean time spent in treated and control regions were compared using a paired t-test (GraphPad Prism Ver. 7) after calculating the mean time spent per control arm and standard error for each replicate.

### Example 14: Oviposition Assay

Agarose plates with oviposition stimulant (OS; γ-octalactone) with synthetic blend of green tree ants headspace volatiles with 1-octanol (BL+CX) or without 1-octanol (BL-CX) and 1-octanol alone (CX) were used as oviposition substrate to determine the repellent/oviposition deterrent activity of 1-octanol to gravid females. Agarose (0.8 g in 100 ml water) was melted in a microwave, was cooled to 40° C. and appropriate amount of the oviposition stimulant (5 ul) in combination with BL+CX, BL-CX or CX was added. This mixture was poured into Petri plates and cooled at 0° C. This was done to enhance setting of the mixture and lower volatile vaporization. Oviposition substrates were prepared freshly when required. Next, oviposition plate containing OS alone, OS+BL+CX, OS+BL-CX and OS+CX was provided to gravid females (100 gravid females 15-20 days old) in cages to make a choice and direct their eggs. The eggs laid in each plate were counted under a stereo-dissecting microscope (Olympus SZX-12, Japan). Ten replicates of choice test were carried out.

14.1 Oviposition Assay for Bactrocera tryoni

Agar plates with oviposition stimulant (OS; γ-octalactone) with 1-octanol (1.17% w/v) or 1-nonanol (1.17% w/v) were used as oviposition substrate to determine the oviposition deterrent activity of 1-octanol and 1-nonanol to gravid female B. tryoni. Agarose (0.8 g in 100 ml water) was melted in a microwave, was cooled to 40° C. and appropriate amount of the oviposition stimulant in combination with 1-octanol or 1-nonanol was added. This mixture was poured into Petri plates and cooled at 0° C. in a refrigerator. This was done to enhance setting of the mixture and lower volatile vaporization. Oviposition substrates were prepared freshly when required. Oviposition plate containing OS alone (control), OS+1-octanol or OS+1-nonanol was provided to gravid females (50 gravid females; 15-20 days old) in cages (30×30×30 cm) to lay eggs. The eggs laid in each plate was enumerated under a stereo-dissecting microscope (Olympus, Japan). Thirty replicates for each test compound and control were carried out.

14.2 Oviposition Assay for Bactrocera jarvisi

Agar plates with oviposition stimulant (MJ: Mango Juice) with 1-octanol (1.17%) or 1-nonanol (1.17%) were used as oviposition substrate to determine the oviposition deterrent activity of 1-octanol and 1-nonanol to gravid female B. jarvisi. Agar (0.8 g in 100 ml of diluted mango juice with water; 1:1) melted in a microwave, was cooled to 40° C. and appropriate amount of 1-octanol or 1-nonanol was added. This mixture was poured into Petri plates and cooled to 0° C. in a refrigerator. This was done to enhance setting of the mixture and lower volatile vaporization. Oviposition substrates were prepared freshly when required. Oviposition plate containing MJ alone (control), MJ+1-octanol or MJ+1-nonanol was provided to gravid females (20 gravid females; 15-20 days old) in cages (30×30×30 cm) to lay eggs. The eggs laid in each plate was enumerated under a stereo-dissecting microscope (Olympus, Japan). Twenty four replicates for each test compound and control were carried out.

14.3 Oviposition Assay for Zeugodacus cucumis

Agar plates applied with oviposition stimulant (OS: fresh zucchini juice) with 1-octanol (1.17% w/v) or 1-nonanol (1.17% w/v) were used as oviposition substrate to determine the oviposition deterrent activity of 1-octanol and 1-nonanol to gravid female Z. cucumis. Agar (0.8 g in 100 ml water) was melted in a microwave, was cooled to 40° C. and poured into Petri plates and cooled at 0° C. Oviposition stimulant alone or OS mixed with 1-octanol or 1-nonanol (50 ul) was spread on agarose plates. Oviposition substrates were prepared freshly when required. Oviposition plate containing OS alone (control), OS+1-octanol or OS+1-nonanol was provided to gravid females (20 gravid females; 15-20 days old) in cages (30×30×30 cm) to lay eggs. The eggs laid in each plate was enumerated under a stereo-dissecting microscope (Olympus, Japan). Twenty four replicates for each test compound and control were carried out.

14.4 Oviposition Assay for Ceratitis capitata

Red seedless grapes from IGA express (Murdoch University, Perth) washed with warm water thrice and dried with paper towel were used as oviposition substrate. Solution of 1-octanol (1.17% w/v) or 1-nonanol (1.17% w/v) were made by mixing appropriate amounts of 1-octanol or 1-nonanol in water with ethanol as an emulsifier. Washed grapes of equal size, dipped into the above solutions for 15-20 sec, was provided to gravid females (50 gravid females; 15-20 days old) in cages (30×30×30 cm) to lay eggs. Grapes that were dipped in water and emulsifier mixture was used as control. Eggs laid in each grapes was enumerated under a stereo-dissecting microscope (Olympus, Japan). Forty replicates for each test compound and control were carried out.

14.5 Oviposition Assay for Bactrocera kraussi

Oranges from Woolworths (Marsfield, NSW) were washed with warm water and dried with paper towel. They were peeled and segmented and a single segment was used as oviposition substrate. Solution of 1-octanol (1.17% w/v) or 1-nonanol (1.17% w/v) were made by mixing appropriate amounts of 1-octanol or 1-nonanol in water with ethanol as an emulsifier. Orange segments of equal size, dipped into the above solutions for 15-20 sec, was provided to gravid females flies (20 gravid females; 20 days old) in cages (30×30×30 cm) to lay eggs. Orange segments dipped in water and emulsifier mixture was used as control. Eggs laid in each orange segment was enumerated under a stereo-dissecting microscope (Olympus, Japan). Twelve replicates for each test compound and control were carried out.

### Example 15: Preparation of Blends

GC responses of the identified compounds in headspace samples were used to prepare two artificial blends of the compounds. One blend contained all the headspace components, while the other excluded 1-octanol only. Stock solutions of the compounds in hexane were prepared in a 10 mL volumetric flask. The stock solutions were diluted to give a concentration of 5.0 μg/mL for all compounds. The diluted samples were run through GC to obtain response factors for the given concentration. The response factor of undecane was used as a reference to adjust the amounts of the compounds to be added in an artificial blend. Appropriate aliquots of the compounds obtained by estimating the amount of a compound from the ratio of response factor of the compound to that of undecane were added to a 10 mL volumetric flask and the flask was filled with hexane to the mark. The artificial blends were subjected GC runs to confirm if the relative total ion chromatogram intensities of the compounds were consistent with that in the natural headspace volatile extracts. The whole procedure was repeated with varying the amounts of the compounds each time until the relative intensities were consistent with that in the natural extract.

### Example 16: Mating Disruption of 1-Octanol in Bactrocera tryoni

Mating assays were carried out at dusk, the normal mating time of B. tryoni. A pair of 15-day old male and female flies were introduced into a behavioural arena 30 min before the onset of dusk. They were allowed to acclimatize for 20 min after which 1-octanol or filtered air was pumped through the inlet of the arena. Five microliters of 1-octanol was applied on a clean filter paper. This filter paper was placed into an air-tight vessel with an inlet and outlet. Charcoal filtered air (1 litre per hour) was pumped into the vessel from the inlet and the outlet was connected to the inlet of the arena with flies. Air from a vessel with clean filter paper was used as control. Fifteen pairs were set up for both 1-octanol treatment and air control. The activity of flies was recorded overnight, and the video was analysed using BORIS software. Collected data included (1) whether a pair mated, (2) Number of copulation attempts, and (3) copula duration.

16.1 Flies do not Mate when Exposed to 1-Octanol

1-Octanol had a very strong effect on mating behaviour of the flies. Of the 15 trials set up in the air control, 13 (87%) of male flies attempted mating, and all that attempted mounting were successful. Flies that succeeded in mating made a median of 2 attempts (range 1-4) and copulated fora median of 35 minutes (range 19-62 minutes). These data are within the normal range. In contrast, of the 15 trials set up with 1-octanol, none attempted mating and consequently none were successful (Comparison to control, for both Fishers Exact Test P<0.00001). These results provide strong evidence that 1-octanol produced by ants is responsible for the complete elimination of mating activity in trials using live ants as an odour source.

### Field Cage Evaluation

### Example 17: Insects

Bactrocera tryoni were obtained from a colony that originated in central coastal New South Wales and had been maintained in a controlled environment laboratory at Macquarie University (25±0.5° C., 65±5% RH, photoperiod of 11.5:0.5:11.5:0.5 light: dusk: dark: dawn) for 39 generations. The progeny of this colony was used in all experiments in Example B. Adult flies were provided yeast hydrolysate, sugar and water ad libitum and were used in experiments at 10 to 15 days of age, when sexually mature. For each trial, four sets of 100 flies (50 males and 50 females) were transferred to mesh cages (32.5×32.5×32.5 cm; Bugdorm-43030F, Megaview, Taiwan), with yeast hydrolysate, sugar and water available ad libitum. The cages were placed outside in a sheltered location for 24 h to allow the flies acclimatize. The cages of flies were then placed inside field cages (details below) 30 min before releasing the flies and initiation of the trials.

### Example 18: Chemicals

All chemicals and solvents used in the synthesis of gelators were purchased from Sigma-Aldrich, Merck, Ajax Finechem or Alfa-Aesar and used without further purification. 12-Hydroxy Stearic Acid (12-HSA; >80% pure) was from TCI (Japan) and 1-octanol (98% pure) was from Sigma-Aldrich (USA).

### Example 19: General Synthetic Procedure

¹H and ¹³C Nuclear Magnetic Resonance (NMR) spectra were recorded using a Bruker AVANCE DPX 400 operating at 400 MHz for ¹H NMR and at 101 for ¹³C NMR. (CD₃)₂SO was used as a solvent for all NMR samples. ¹H NMR chemical shifts are reported in parts per million (δ) referenced to the proton signal of the deuterated solvent ((CD₃)₂SO; 2.54 ppm), whereas 13C NMR chemical shifts are reported with reference to the carbon signals of the deuterated solvent ((CD₃)₂SO; 40.45 ppm). The following abbreviations are used to describe the NMR data—singlet (s), doublet (d), doublet of doublet (dd), doublet of doublet of doublet (ddd), and multiplet (m). The progress of reaction was monitored with thin layer chromatography (TLC), which was performed using Merck TLC silica gel 60 F₂₅₄ on aluminium sheets (0.2 mm) and visualized with potassium permanganate staining solution. Solvents were removed under reduced pressure using a Buchi Rotavapor R-200, Buchi V-500 vacuum pump, and Buchi B-490 heating bath set to a temperature of 40° C. Drying following solvent removal was performed with an Alcatel Pascal 2005 SD high vacuum pump. Flash column chromatography was performed using Merck 60 silica gel (40-60 μm) and a M1 Class chromatographic pump (Teledyne SSI, PA, US).

### Example 20: Synthesis of Mannitol 1,6-dioctanoate (M8) and α,α-trehalose 6,6′-dioctanoate (T8)

For synthesising mannitol 1,6-dioctanoate, mannitol (6.0 mmol, 1.0 g, 1.0 eq), vinyl octanoate (15.0 mmol, 2.6 g, 3.5 eq) and activated molecular sieves (20 g) in 40 mL of dry acetone was added to lipase B (200 U) in a screw-capped glass vial. Prior to the reaction, acetone was dried using 3 A° molecular sieve that was activated by heating to 400° C. in an oven for 24 hours. The above mixture was stirred continuously at 200 rpm (48 h) in an incubator shaker set to 45° C. The reaction was cooled to room temperature and filtered under lowered pressure. The residue was washed with acetone (3×20 mL). The combined filtrate was concentrated in vacuo to give the crude product, which was purified by flash column chromatography (with chloroform:methanol (9:1, v/v) as an eluent. The pure product was obtained as a white solid (1.5 g, 56% yield). For α,α-trehalose 6,6′-dioctanoate, the same method for the synthesis of mannitol-1,6-dioctanoate was used, except that trehalose was used instead of mannitol. The pure product yield was 2.98 g (84% yield, 6.0 mmol scale). The pure products were subjected to structural analysis using NMR.

20.1 ¹H and ¹³C Nuclear Magnetic Resonance (NMR) of Gelators

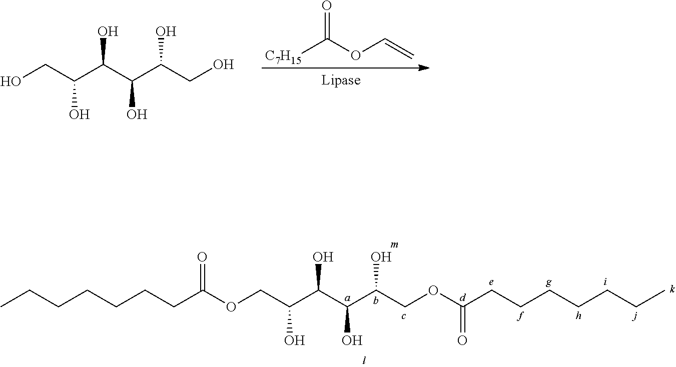

After the purification procedure, gelator obtained as white solid was identified by ¹H and 13C NMR and the analysis data for mannitol 1,6-dioctanoate were as follows:

¹H NMR (400 MHz, MeOH-d4) δ 0.87 (6H, m, k), 1.23 (16H, m, 2 (g, h, l, j)), 1.56 (4H, m, 2 f), 2.30 (4H, t, J=7.5, 2 e), 3.62 (2H, m, 2 a), 3.73 (2H, m, 2 b), 4.01 ((2H, dd, J=11.2, J=6.7, 2 (one of c)), 4.26 (2H, dd, J=11.2, J=2.2, 2 (the other of c)), 4.32 (2H, d, J=7.6, 2 m), 4.75 (2H, d, J=6.0, 2 l); 13C NMR (100 MHz, MeOH-d4) δ 14.7, 23.0, 25.3, 29.3, 29.4, 32.0, 34.5, 67.5, 69.3, 69.9, 173.9 (d).

The analysis data for α,α-trehalose 6,6′-dioctanoate were as follows:

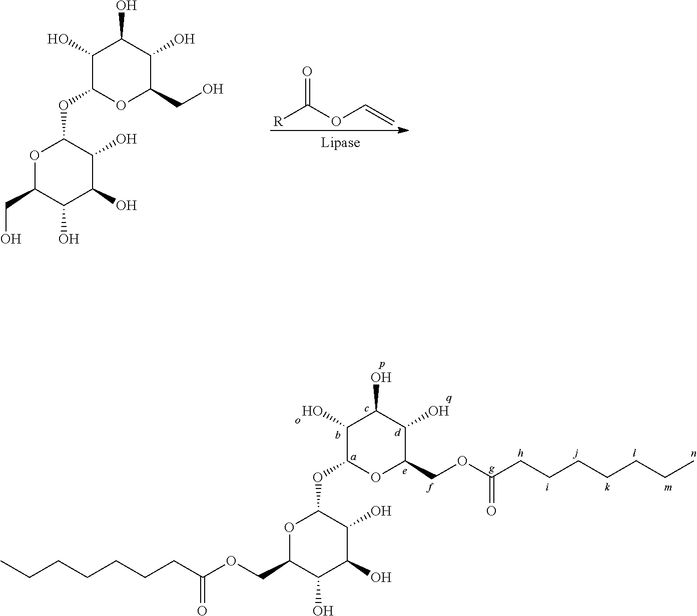

¹H NMR (400 MHz, MeOH-d4) δ 0.89 (6H, t, J=7.1, 2 n), 1.29 (16H, m, 2 (j, k, l, m)), 1.54 (4H, m, 2 i), 2.31 (4H, t, J=7.4, 2 h), 3.16 (2H, m, 2 (b, c, or d)), 3.29 (2H, m, 2 (b, c, or d)), 3.58 ((2H, m, 2 (b, c, or d)), 3.93 (2H, ddd, J=11.7, J=5.4, J=1.9, 2 (one of f)), 4.07 (2H, dd, J=11.5, J=5.5, 2 (the other of f)), 4.26 (2H, dd, J=11.7, J=1.9, 2 e), 4.81 (2H, s, 2 (o, p or q)), 4.85 (2H, d, J=3.6, 2 a), 4.94 (2H, s, 2 (o, p or q)), 5.10 (2H, s, 2 (o, p or q)); 13C NMR (100 MHz, MeOH-d4) δ 14.9, 23.1, 25.5, 29.3, 29.4, 32.1, 34.6, 64.1, 70.7, 71.1, 72.4, 73.7, 94.5, 173.8.

### Example 21: Preparation of Slow-Release Organogels

Gelators [mannitol 1,6-dioctanoate (M8), α,α-trehalose 6,6′-dioctanoate (T8) and 12-hydroxystearic acid (H12) (0.5%, 1%, 2%, 4% w/v for M8 and T8 and 8% and 10% w/v H12)] were weighed and added individually to 50 mL glass beakers containing 1-octanol (10 mL). The mixture was heated to 75° C. using a hotplate with gentle stirring to melt the gelators. After the gelators were completely melted, the mixture was poured into PE vials (1.6 ml; ProSciTech, Thuringowa Central, Australia) and allowed to cool to room temperature and solidify. M8 and T8 formulations required 4% of the gelators and H12 formulation required 10% of the gelator to remain solid in field conditions. As a control, 12-hydro stearic acid (H12) was melted without 1-octanol and poured into PE vials. All PE vials containing the organogels were capped and stored at 4° C. until use.

### Example 22: Field Cage Trials

Field cage trials to assess repellence and oviposition deterrence of 1-octanol formulations (M8, T8 and H12) were conducted between October and December of 2020 at Macquarie University, Sydney, NSW, Australia (33° 46′ 08.2″ S; 151° 06′48.8″ E). Trials were conducted in field cages measuring 300 cm×300 cm×205 cm (Oztrail, Gazebo 3.0 screen house inner kit; Model No. MPGO-SIK30-D, VIC, Australia). Potted citrus trees (ca. 1.2 m height) were placed at the corners of each field cage. Red capsicums were soaked in water overnight and dried with tissue papers. Four field cages were used with each containing 4 potted citrus trees (3 treatment and 1 control). A wooden pole (ca. 1.2 m long) was inserted into the potting mixture of each pot as a support on which to hang capsicums and PE vials with a metal wire. 1-octanol stabilized using different gelators (M8, T8 and H12) was tested for its repellence towards gravid female flies. Gels in PE vials were hung to the wooden pole with a metal wire next to capsicum fruits on treatment trees with the lids open for 1-octanol to disperse. Gel without 1-octanol was used on control trees. Gels were replaced after each trial. Fifty males and 50 females of B. tryoni were released into each field cage. After 48 h the capsicums were recovered. Oviposition punctures were recorded and capsicums were individually placed into plastic containers (Décor Tellfresh Square storer; 1.75 L capacity) in a controlled environment room (25±0.5° C., 65±5% RH, photoperiod of 11.5:0.5:11.5:0.5 light: dusk: dark: dawn) for larval development. After 5 days, the capsicums were cut open and the larvae were counted.

### Example 23: Results

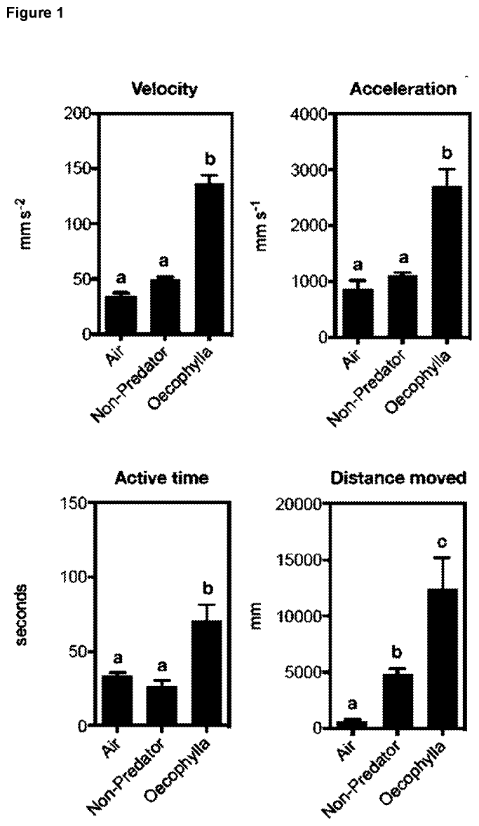

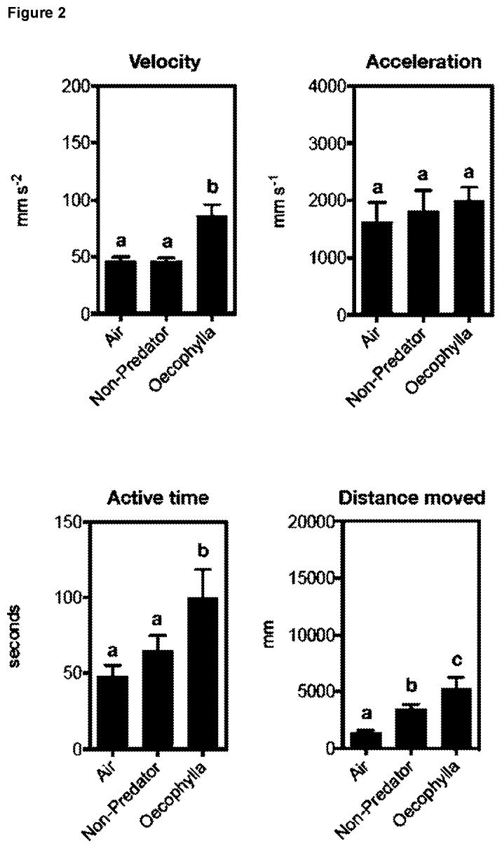

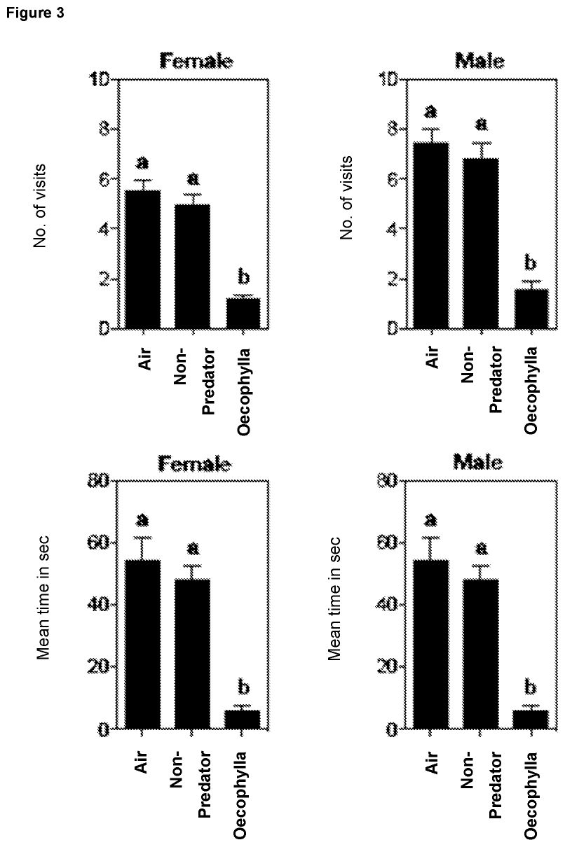

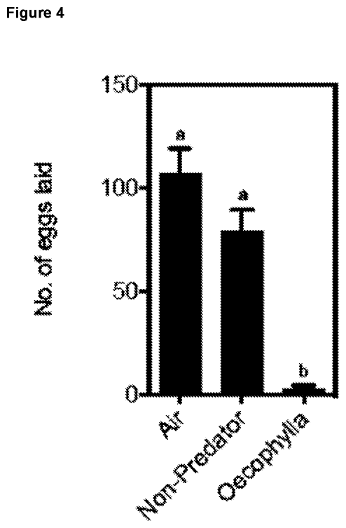

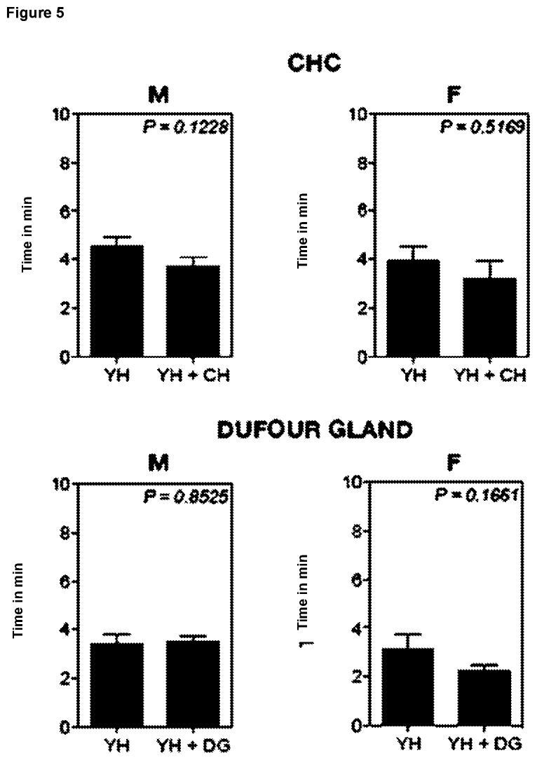

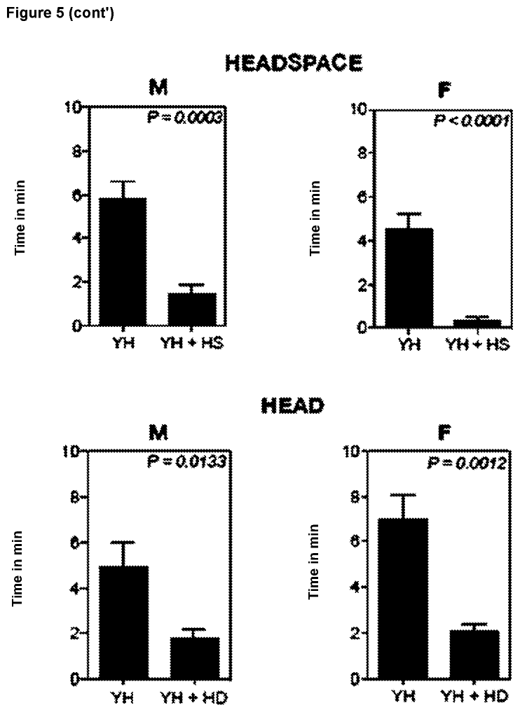

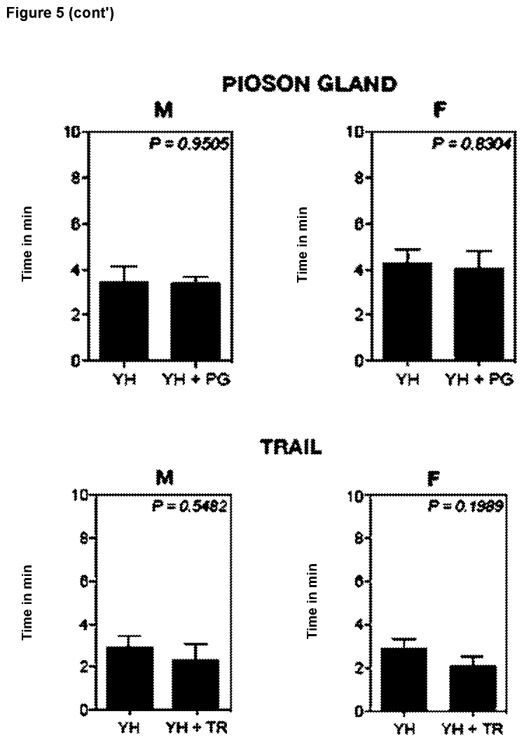

For oviposition count, repeated measures one-way ANOVA found significant differences amongst the groups (F 1.934, 52.22=85.62, P<0.0001; see FIG. 1a). Tukey's multiple comparison indicated that the mean number of punctures in capsicums with gelators (mean±sem: M8 17.79±2.51; T8 19.11±2.02; H12 7.28±0.67) were all significantly lower than the control (34.71±1.40). Within the treated capsicums, H12 had significantly fewer punctures than M8 and T8, which were not different from each other.

A very similar pattern was observed for larval count. Repeated measures one-way ANOVA found significant differences amongst the groups (F 1.846, 49.84=244.7, P<0.0001; see FIG. 1b). Tukey's multiple comparison indicated that the mean number of larvae in capsicums with gelators (mean±sem: M8 19.79±2.9; T8 23.18±4.09; H12 11.29±1.77) were all significantly lower than the control (134.3±6.79). Within the treated capsicums, H12 had significantly fewer larvae than M8 and T8, which were not different from each other.

### 1-Octanol Formulated for Slow-Release is Effective at Reducing Damage to Fruit in an Outdoor Field Cage Context

1-octanol formulated for slow-release using 3 different gelators; M8, T8 and H12 was effective at reducing damage to fruit. All formulations significantly reduced the number of fruit punctures and larvae in treated capsicums. However, the H12 formulation was significantly more effective than other formulations. The differences in effectiveness of the tested formulation likely relates to release rate.

The examples demonstrate protection of fruit from B. tryoni by use of the predator-sourced kairomone (1-octanol or 1-nonanol) in outdoor conditions that come closer to field application than previous laboratory studies. There are numerous advantages of using predator-sourced kairomones such as 1-octanol or 1-nonanol as repellents. Kairomones are effective at a very low concentrations and it should not be necessary to fully cover plants or fruits to achieve a strong effect. Kairomones from predators are often somewhat volatile, such that prey species are able to respond to olfactory cues from a distance rather than through contact chemoreception. As such, kairomones from predators can be formulated into slow-release products such as those used herein to provide a zone of protection around each release device.

### Example 24: EAG Responses of Selected Flies to 1-Octanol and 1-Nonanol

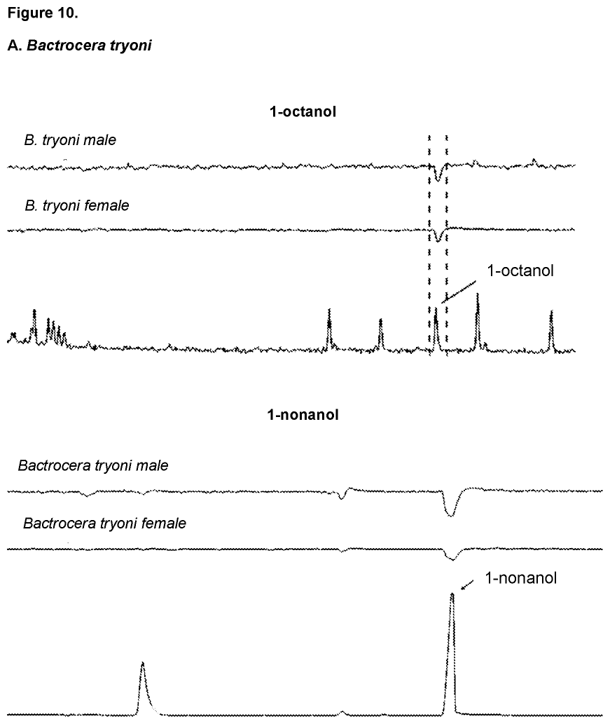

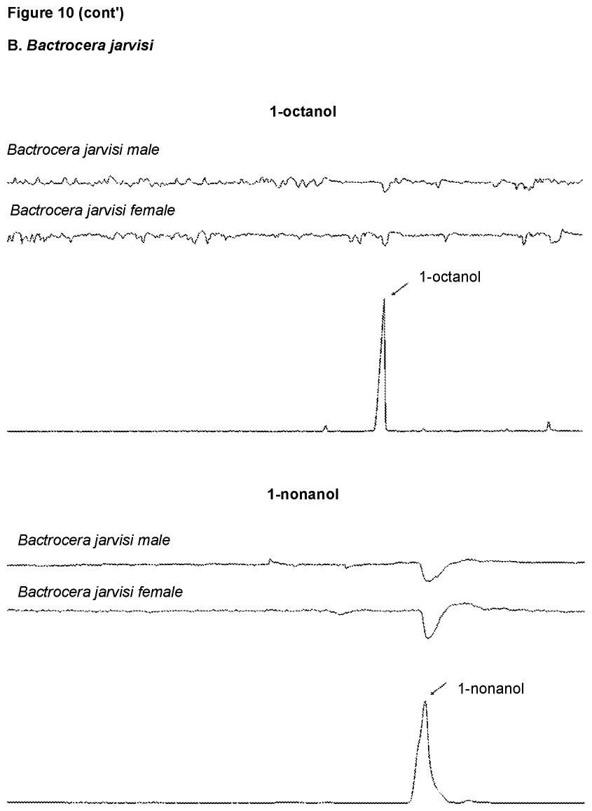

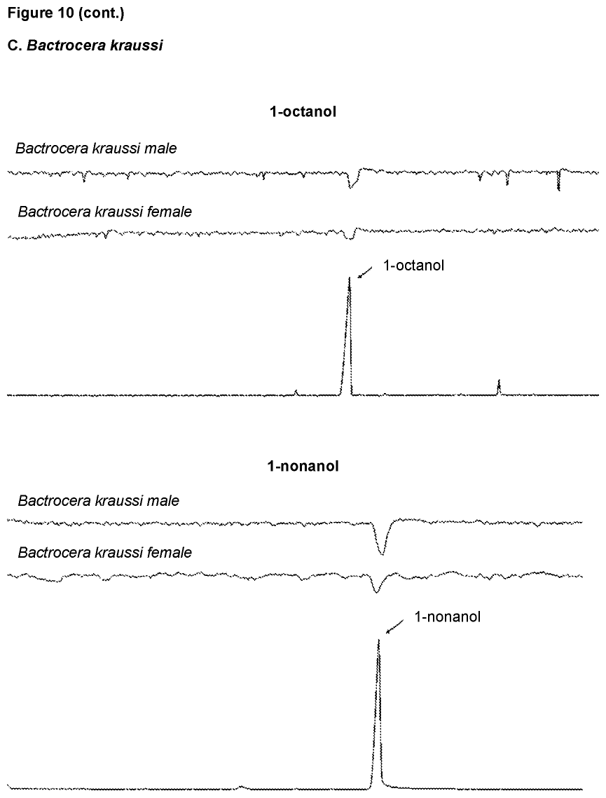

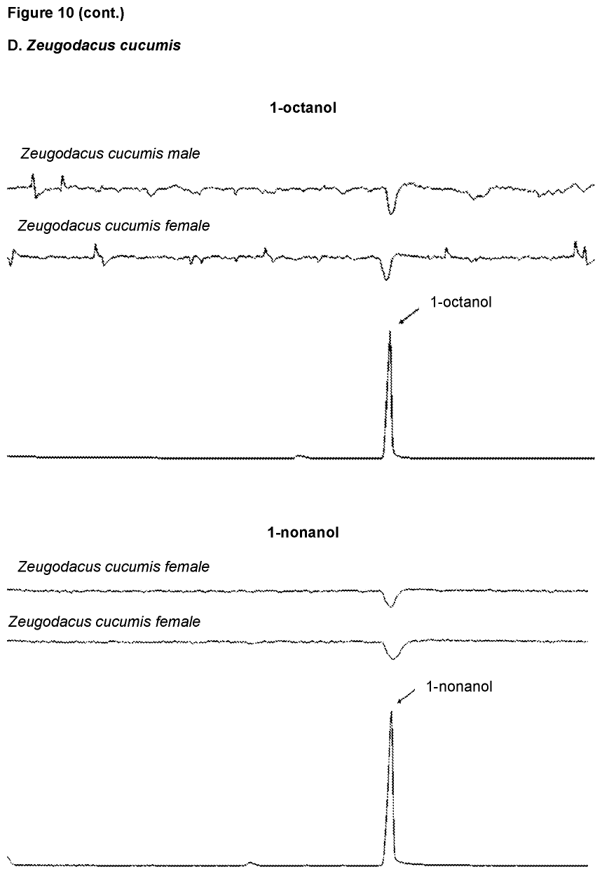

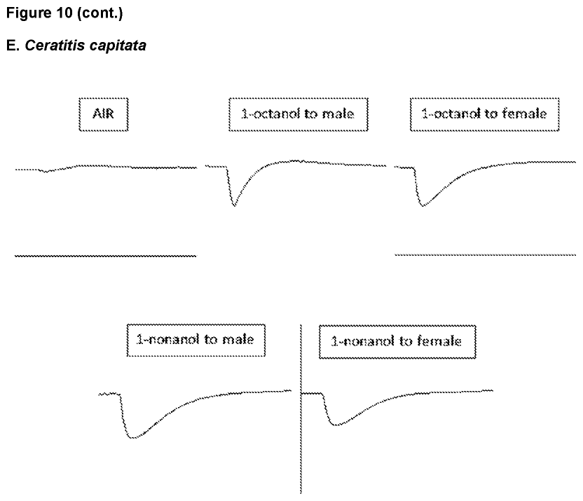

Coupled Gas Chromatography-Electroantennography (GC-EAG) recordings were made with Ag-glass microelectrodes filled with electroconductive gel (Spectra 360, Parker Laboratories Inc., USA). The head of male or female flies (i.e., Bactrocera tryoni, Bactrocera jarvisi, Bactrocera kraussi, and Zeugodacus cucumis) was separated from the body with a microscalpel and was placed on the tip of the indifferent electrode, making sure the base of the head is affixed to the gel in the electrode. The tip of the insect antenna was made to touch the recording electrode and was slightly inserted into the gel to stabilize the antenna. The mounted heads were under charcoal filtered and humidified air flow (2400 mL min-1) controlled by a flow controller (Stimulus Controller CS-55, Syntech, Hilversum, The Netherlands). The signals were passed through a high impedance amplifier (UN-06, Syntech, Hilversum, The Netherlands). 1-octanol or 1-nonanol were tested individually or as mixture of known concentration. After injection of compounds, the effluent from the GC column was simultaneously directed to the antennal preparation and the GC detector. Separation of compounds was achieved on an Agilent Gas Chromatography system equipped with an injector, a fused silica capillary column, SH_Rtx-5Sil MS (30 m×0.25 mm×0.25 μm film thickness) and a flame ionization detector (FID). Hydrogen (99.999% pure, Boc, North Ryde, Australia) with a constant flow of 2.5 mL min-1 was a carrier gas. The injector and detector temperatures were 270° C. and 290° C., respectively. The oven temperature was initially set at 40° C. for 1 min, increased to 260° C. at a rate of 10° C. min-1, and held for 2 mins. The outputs from the EAG amplifier and the FID were monitored simultaneously and analysed using the GCEAD 2014 software v1.2.5 (Syntech, The Netherlands). Peaks eluting from the GC column were found to elicit EAG activity in 100% of trials presenting 1-octanol or 1-nonanol for both sexes of all tested Zeugodacus and Bactrocera species (FIG. 10A, 10B, 10C, and 10D).

For the Medfly, Ceratitis capitata, a standalone EAG was used for antennal recordings. Electroconductive gel (Spectra 360, Parker Laboratories Inc., USA) were applied to the arms of the metal electrodes and the head of male or female fly, separated from the body was affixed onto one of the indifferent metal arm. The recording arm with gel was made to touch a single or both the antenna of the fly. The antennal preparation was inserted to the EAG probe holder that was under filtered and humidified air the same as described above. The EAG signals were passed through a high impedance amplifier (UN-06, Syntech, Hilversum, The Netherlands). 1-Octanol or 1-nonanol of known concentrations were tested individually. The compounds (10 ul) were dispensed on a filter paper and were placed into a pasture pipette. The prepared pipettes were fixed tubing from the stimulus controller (CS-55, Syntech, The Netherlands) and the stimulus was puffed over the antennal preparation. The response was record using EAGPro software (Syntech, The Netherlands). Ten replicates were recorded for each compound per sex, with EAG activity confirmed in 100% of trials presenting 1-octanol or 1-nonanol for both sexes of C. capitata (FIG. 10E).

1. A composition comprising 1-octanol, 1-nonanol, or a combination thereof; and at least one carrier, wherein the composition is capable of modifying a behaviour of a tephritid fruit fly.

2. The composition of claim 1, wherein the behaviour modification is selected from deterring or reducing oviposition, deterring, or reducing feeding, deterring, or reducing mating, and movement away from the 1-octanol, 1-nonanol, or the combination of 1-octanol and 1-nonanol.

3. The composition of claim 1, wherein the carrier is a matrix, solvent, wax emulsion, wax, or a polymer.

4. The composition of claim 3, wherein the carrier is adapted to provide sustained or control release of the 1-octanol, 1-nonanol, or a combination thereof.

5. The composition of claim 3, wherein the matrix is a gelator selected from mannitol 1,6-dioctanoate (M8), α,α-trehalose 6,6′-dioctanoate (T8), 12-hydroxystearic acid (H12), and any combination thereof.

6. The composition claim 5, wherein the composition comprises 0.5% w/w to 10% w/w of the gelator.

7. The composition of claim 3, wherein the solvent is selected from water, acetone, DMSO, methyl acetate, ethyl acetate, diethyl ether, diisopropyl ether, tetrahydrofuran, acetonitrile, or an alcohol such as methanol, ethanol, butanol, isopropanol, or glycerol.

8. The composition of claim 3, wherein the wax emulsion, is selected from a SPLAT emulsion, or an emulsion of paraffin, beeswax, a vegetable-based wax, a hydrocarbon-based wax, carnauba wax, lanolin, shellac wax, bayberry wax, sugar cane wax, a microcrystalline wax, ozocerite, ceresin, montan, candelilla wax, and combinations thereof.

9. The composition of claim 3, wherein the polymer is selected from polyvinyl chloride, polyethylene, cellulose acylate, cellulose ethyl ether, cellulose diacylate, cellulose triacylate, cellulose acetate, cellulose diacetate, cellulose triacetate, a cellulose alkan, a cellulose aroyl, ethyl cellulose, cellulose acetate, cellulose acetate butyrate, cellulose acetate phthalate, cellulose acetate trimellitate, glyceryl monooleate, glyceryl monostearate, glyceryl palmitostearate, polyvinyl acetate phthalate, hydroxypropylmethylcellulose phthalate, hydroxypropylmethylcellulose acetate succinate, poly(alkyl methacrylate), poly(vinyl acetate), a poly vinyl alcohol, a polyacrylamide derivative, an ammonio methacrylate copolymer, poly acrylic acid and poly acrylate and methacrylate copolymers, aminoacryl-methacrylate copolymer, polyvinyl acetaldiethylamino acetate, copolymers of maleic anhydride and styrene, ethylene, propylene or isobutylene, a polyacrylamide, a polyox(polyethylene oxide), a diester of polyglucan, cellulose butyrate, cellulose propionate, shellac, chitosan, oleyl alcohol, zein, vegetable oil, an essential oils, and hydrogenated castor oil.

10. The composition of claim 3, wherein the wax is selected from carnauba wax, beeswax, Chinese wax, spermaceti, lanolin, bayberry wax, white wax, yellow wax, candelilla wax, microcrystalline wax, castor wax, esparto wax, Japan wax, ouricury wax, rice bran wax, a ceresin wax, montan wax, ozokerite, a peat wax, paraffin wax, a polyethylene wax, and polyglycerol fatty acid esters.

11. A controlled release device comprising an effective amount of the composition defined in claim 1.

12. A method of modulating the behaviour of a tephritid fruit fly comprising
a) identifying a target area frequented or likely to be frequented by fruit flies;
b) applying to a portion of the area an effective amount of the composition defined in claim 1; and/or
c) placing a controlled release device in the area.

13. The method of claim 12, further comprising further applications of an effective amount of 1-octanol, 1-nonanol, a combination thereof or the composition defined in claim 1.

14. (canceled)

15. The method of claim 13, wherein the further applications are daily, every two days, every four days, every six days, weekly, two weekly, three weekly, or monthly.

16. The method of claim 12, wherein the behaviour modulation is one or any combination of a reduction in the incidence of oviposition, feeding, mating, and movement into the area.

17. The method of claim 12, wherein the area comprises a fruit or a fruit tree.

18. A method of modulating the behaviour of a tephritid fruit fly comprising administering to the tephritid fruit fly a composition comprising an effective amount of the composition defined in claim 1 to modulate the behaviour of the tephritid fruit fly.

19. The method of claim 18 wherein the composition is present in a matrix or in the controlled release device of claim 11.

20. (canceled)

21. The method of claim 18, wherein the modulation is one or any combination of a reduction in the incidence of oviposition, feeding, mating, and movement towards the 1-octanol, 1-nonanol, or combination thereof.

22. The composition of claim 1 wherein the tephritid fruit fly is selected from the genera, Bactrocera, Dacus, Zeugodacus, Ceratitis, Rhagoletis, or Anastrepha.

23. (canceled)

24. (canceled)

25. (canceled)

26. (canceled)

27. (canceled)
